(19) United States
(12) Patent Application Publication
(10) Pub. No.: US 2014/0347750 A1
(43) Pub. Date: Nov. 27, 2014

(54) CENTERING METHOD, CENTERING APPARATUS, AND LENS POSITIONING UNIT

(71) Applicant: HOYA CORPORATION, Tokyo (JP)

(72) Inventors: Teruo Yamashita, Tokyo (JP); Hideki Mutou, Tokyo (JP); Norihiro Shiozawa, Tokyo (JP)

(21) Appl. No.: 14/361,852

(22) PCT Filed: Nov. 30, 2012
(86) PCT No.: PCT/JP2012/081212

§ 371 Date: Aug. 7, 2014

(30) Foreign Application Priority Data
Dec. 1, 2011 (JP) 2011-263310

(51) Int. Cl. B24B 13/005; G02B 7/02

(52) U.S. Cl. CPC B24B 13/0055; G02B 7/02
USPC 359/818

(57) ABSTRACT

A centering method for holding a lens, which has been molded using a molding die, between a pair of holders of a bell clamp system, and centering the outer circumference of the lens, this method including: a first step of using a planar part of the lens, formed using a molding surface of a molding die, to position the lens with respect to a guidance part of a positioning member configured to enable the positioning of the lens, and a second step of holding the lens between one and the other holders and another holder so that the optical axis of the lens positioned in the first step aligns with the central axis of the one holder. It is possible to prevent the optical surface of the workpiece lens and an antireflective film from being scratched when centering an aspherical lens or a spherical lens as the workpiece lens.

### TECHNICAL FIELD

The present invention relates to a method for centering a lens, a centering apparatus, and a lens positioning unit.

### BACKGROUND ART

Generally speaking, the lenses used in a digital single-lens reflex camera, a video camera, or the like, include those that are manufactured using a lens molding process and a centering process. The lens molding process is for molding the lens using a molding die. The centering process is for grinding the outer circumference of a lens obtained by the lens molding process so that the lens exhibits the desired outside diameter and the circumferential shape of the lens becomes a perfect circle having the optical axis of the lens at the center.

In the lens centering process, a bell clamp system for holding the lens at processing time is known (for example, refer to PTL 1 and PTL 2). The bell clamp system is for insertingly supporting (hereinafter, also referred to as “holding between”) a lens using a pair of holders arranged coaxially. The holders are formed in a cylindrical shape having an opening in the side that comes in contact with the lens.

When actually holding a lens to perform centering, first, the lens is mounted in the one holder, and thereafter, the other holder is brought closer to the one holder (lens), thereby supporting the lens by inserting the lens between the pair of holders. The open ends of the holders come in contact with the optical surfaces of the lens corresponding thereto from both sides of the lens at this time. At this stage, the holding pressure by the pair of holders is configured low.

When the lens is being held between the pair of holders like this and the pair of holders is rotated in this state, the lens performs a sliding movement while being subjected to the aforementioned holding pressure, whereby the lens is automatically centered. Specifically, when the pair of holders is rotated in a state in which the axis of rotation of the pair of holders is not aligned with the optical axis of the lens, the lens slides in the direction in which these axes will be aligned, thereby centering the lens.

After centering the lens like this, while the pair of holders is being rotated, the holding pressure by the pair of holders is configured higher than the pressure up to the point at which the lens was centered (specifically, enough pressure so that the lens will not shift during the centering process). The lens thereby integrally rotates with the pair of holders. In this state, a grinding wheel is brought into contact with the outer circumference of the rotating lens. This makes it possible to grind (centering process) the outer circumference of the lens.

### CITATION LIST

### Patent Literature

### [PTL 1]

### Japanese Patent Application Laid-open No. 2009-274155

### [PTL 2]

### Japanese Patent Publication No. 4084919

### SUMMARY OF INVENTION

### Technical Problem

Now then, there are a spherical lens and an aspherical lens, as types of lens obtained by the above-described lens molding process. In the case of the spherical lens, the optical surface of the lens is formed with a uniform curvature. Therefore, when the pair of holders is brought into contact with the optical surface of the lens and the lens is held therebetween and rotated, the lens is more apt to slide smoothly. Alternatively, in the case of the aspherical lens, the optical surface of the lens is not formed with a uniform curvature. In addition, the shape difference (aspherical surface quantity) of the optical surface of the aspherical lens increases with respect to the optical surface of the spherical lens in accordance with the distance in the radial direction from the optical axis of the lens.

The pair of holders was originally formed in a cylindrical shape to more easily adapt to the optical surface of the spherical lens. Therefore, in the case of the aspherical lens, when the holders are brought into contact with the optical surface of the lens and the lens is held therebetween and rotated, the open ends of the holders are in unsymmetrical contact with the lens as a result of the lens shifting prior to centration, making it easy for the holders to get hold of the lens. Therefore, in a case where lens centering is performed by rotating the holders, the aspherical lens does not slide as easily as the spherical lens. As a result, the problem is that when centering an aspherical lens, scratches are readily formed in the optical surface of the lens caused by the rubbing of the holders on the optical surface of the lens. In particular, when centering an aspherical lens having an optical surface coated with an antireflective film, the sliding of the lens worsens due to minute irregularities in the antireflective film, thus creating a situation in which the optical surface of the lens and the antireflective film are susceptible to scratching.

The prevention of scratches in the optical surface of a lens (in a case where an antireflective film has been formed on the optical surface, the prevention of scratches in the optical surface and the antireflective film) is also desirable for a spherical lens, either in place of or in addition to an aspherical lens.

Subsequent to the centering process, for example, the lens is mounted in the lens-barrel of an optical instrument using either a planar part or the outer circumference of the lens as a reference. The problem is that when the precision of either reflection decentration or transmission decentration is low at mounting time, the ill effects thereof are evident in the optical characteristics of the optical instrument. Therefore, to enhance the precision of either reflection decentration or transmission decentration, it is desirable that the shifting of the lens during the centering process be kept as small as possible.

A main object of the present invention is to provide a technique for preventing scratches from forming in the optical surface of a workpiece lens (the optical surface and the antireflective film of the workpiece lens when an antireflective film has been formed on the optical surface of the workpiece lens) even when centering is performed on a lens (typically, a lens having at least one of a spherical surface or an aspherical surface) as the workpiece lens.

### Solution to the Problem

A first aspect of the present invention is a centering method for holding a workpiece lens, which has been molded using a molding die, between a pair of holders of a bell clamp system, and centering an outer circumference of the workpiece lens, this method including: a first step of using a first reference part of the workpiece lens, which is formed using a molding surface of a molding die, to position the workpiece lens with respect to a second reference part of a positioning member configured to enable the positioning of the workpiece lens; and a second step of holding the workpiece lens between one and the other holders so that the optical axis of the workpiece lens, which is positioned in the first step, aligns with the central axis of the one holder.

A second aspect of the present invention is a centering method according to the first aspect, wherein the first reference part includes the outer circumference part of the workpiece lens, or a planar part configured to extend in the radial direction from the outer peripheral edge of the optical surface of the workpiece lens.

A first example of the second aspect of the present invention is a centering method according to the first aspect, wherein the workpiece lens has the outer peripheral surface of the workpiece lens as a first reference part, and in the first step, the positioning of the workpiece lens is performed using the outer peripheral surface of the workpiece lens, thereby allowing the optical axis of the workpiece lens to be either parallel to or substantially aligned with the reference axis of the positioning member.

A second example of the second aspect of the present invention is a centering method according to the first aspect, wherein the workpiece lens has a planar part extending in the radial direction from the outer peripheral edge of the optical surface of the workpiece lens as a first reference part, and in the first step, the positioning of the workpiece lens is performed using the planar part of the workpiece lens, thereby allowing the optical axis of the workpiece lens to be either parallel to or substantially aligned with the reference axis of the positioning member.

A third example of the second aspect of the present invention is a centering method according to the first aspect, wherein the workpiece lens has a planar part extending in the radial direction from the outer peripheral edge of the optical surface of the workpiece lens and the outer peripheral surface of the workpiece lens as a reference part, and in the first step, the positioning of the workpiece lens is performed using as a first reference surface the outer peripheral surface and the planar part of the workpiece lens, thereby allowing the optical axis of the workpiece lens to be either parallel to or substantially aligned with the reference axis of the positioning member.

A third aspect of the present invention is a centering method according to the first or second aspect, wherein the molding die has: a first molding surface configured to mold the optical surface of the workpiece lens; and a second molding surface configured to have a third reference part forming the first reference part on the outer side of the first molding surface, wherein the workpiece lens is positioned so as to align the first reference part, which is formed by the third reference part, with the second reference part.

A fourth aspect of the present invention is a centering method according to the third aspect, wherein the third reference part includes a planar part having, on the second molding surface, a planar surface orthogonal to the central axis of the molding die, the first reference part is formed when the planar part is transferred to the workpiece lens during press molding using the molding die, and the workpiece lens is positioned so as to align the first reference part with the second reference part.

A fifth aspect of the present invention is a centering method according to the third aspect, wherein the third reference part includes, on the second molding surface, an outer peripheral surface part parallel to the central axis of the molding die, the outer peripheral surface part is configured to form the outer circumference of the workpiece lens, the first reference part is formed when the outer peripheral surface part is transferred to the workpiece lens during press molding using the molding die, and the workpiece lens is positioned so as to align the first reference part with the second reference part.

A sixth aspect of the present invention is a centering method according to any one of the first through the fifth aspects, wherein the second reference part is a reference axis of the positioning member, and the positioning in the first step corrects the optical axis so as to be parallel to the reference axis.

A seventh aspect of the present invention is a centering method according to any one of the first through the sixth aspects, wherein the second reference part is the reference axis of the positioning member, and the positioning in the first step corrects the optical axis so as to intersect the reference axis.

An eighth aspect of the present invention is a centering method according to any one of the first through the seventh aspects, wherein the second step includes moving the workpiece lens that has been positioned in the first step from the position, in which the workpiece lens has been positioned, to the pair of holders, and processing the workpiece lens held therebetween.

A ninth aspect of the present invention is a centering apparatus for holding a workpiece lens, which is molded using a molding die, between a pair of holders of a bell clamp system and centering the outer circumference of the workpiece lens, the centering apparatus including: a positioning unit configured to use a first reference part of the workpiece lens, which has been molded by a molding surface of the molding die, to position the workpiece lens with respect to a second reference part of a positioning member configured to enable the positioning of the workpiece lens; and a processing unit configured to have a pair of holders for holding the workpiece lens, which is positioned by the positioning unit, between one and the other holders so that the optical axis of the workpiece lens, which is positioned by the positioning unit, aligns with the central axis of the one of the holders, and configured to center the outer circumference of the workpiece lens.

A tenth aspect of the present invention is a centering apparatus according to the ninth aspect, wherein a first reference part includes the outer circumference of the workpiece lens, or a planar part configured to extend in the radial direction from the outer peripheral edge of the optical surface of the workpiece lens.

An eleventh aspect of the present invention is a centering apparatus according to either the ninth or tenth aspect, wherein the molding die has: a first molding surface configured to mold the optical surface of the workpiece lens; and a second molding surface configured to have a third reference part for forming the first reference part on the outer side of the first molding surface, the positioning unit is configured to position the workpiece lens so as to align the first reference part formed by the third reference part with the second reference part.

A twelfth aspect of the present invention is a centering apparatus according to the eleventh aspect, wherein the third reference part includes a planar part having, on the second molding surface, a planar surface orthogonal to the central axis of the molding die, the first reference part is formed when the planar part is transferred to the workpiece lens during press molding using the molding die, and the positioning unit is configured to position the workpiece lens so as to align the first reference part with the second reference part.

A thirteenth aspect of the present invention is a centering apparatus according to the eleventh aspect, wherein the third reference part includes, on the second molding surface, an outer peripheral surface part parallel to the central axis of the molding die, the outer peripheral surface part forms the outer circumference of the workpiece lens, the first reference part is formed when the outer peripheral surface part is transferred to the workpiece lens during press molding using the molding die, and the positioning unit is configured to position the workpiece lens so as to align the first reference part with the second reference part.

A fourteenth aspect of the present invention is a centering apparatus according to any one of the ninth through the thirteenth aspects, wherein the second reference part is the reference axis of the positioning member, and the positioning performed by the positioning unit corrects the optical axis so as to be parallel to the reference axis.

A fifteenth aspect of the present invention is a centering apparatus according to any one of the ninth through the fourteenth aspects, wherein the second reference part is the reference axis of the positioning member, and the positioning performed by the positioning unit corrects the optical axis so as to intersect the reference axis.

A sixteenth aspect of the present invention is a centering apparatus according to any one of the ninth through the fifteenth aspects, wherein the second step includes moving the workpiece lens that has been positioned in the first step from the position, in which the workpiece lens has been positioned, to the pair of holders, and processing the workpiece lens held therebetween.

A seventeenth aspect of the present invention is a centering unit for holding a workpiece lens, which has been molded using a molding die, between a pair of holders of a bell clamp system and centering an outer circumference of the workpiece lens, the lens positioning unit implementing positioning of the workpiece lens prior to mounting the workpiece lens to one of the holders, wherein the workpiece lens has a first reference part molded by a molding surface of the molding die, the lens positioning unit has a positioning member having a second reference part for enabling the positioning of the workpiece lens, and the lens positioning unit is configured to enable the positioning of the workpiece lens by either bringing the first reference part into contact with or close proximity to the second reference part.

### Advantageous Effects of Invention

According to the present invention, it is possible to effectively prevent damage to the optical surface of a workpiece lens (the optical surface and the antireflective film of the workpiece lens when an antireflective film has been formed on the optical surface of the workpiece lens) even when centering a lens (typically, a lens having at least one of a spherical surface or an aspherical surface) as the workpiece lens.

### BRIEF DESCRIPTION OF DRAWINGS

FIG. 1 is a schematic diagram for illustrating an overview of a centering apparatus related to a first embodiment of the present invention.

FIG. 2 is a diagram illustrating lens misalignment.

FIG. 3 is a cross-sectional view showing the structure of a molding die and the structure of a lens related to the first embodiment of the present invention.

FIG. 4 is a schematic cross-sectional view showing an example of the structure of a positioning unit related to the first embodiment of the present invention.

FIG. 5 is a diagram illustrating an example of another structure of the positioning unit related to the first embodiment of the present invention.

FIG. 6 is a cross-sectional view showing the structure of a molding die and the structure of a lens related to a second embodiment of the present invention.

FIG. 7 is a schematic diagram showing an example of the structure of a positioning unit related to the second embodiment of the present invention.

FIG. 8 is a schematic planar view showing an example of a variation of the positioning unit related to the second embodiment of the present invention.

FIG. 9 is a diagram illustrating examples of other structures for the molding die and lens related to the second embodiment of the present invention.

FIG. 10 is a diagram illustrating the structure of a molding die and the structure of a lens related to a third embodiment of the present invention.

FIG. 11 is a cross-sectional view showing an example of the structure of a positioning unit related to the third embodiment of the present invention.

### DESCRIPTION OF EMBODIMENTS

The embodiments of the present invention will be explained in detail below while referring to the drawings.

The embodiments of the present invention will be explained in the following order.

1. The first embodiment
1-1. Overview of centering apparatus
1-2. Centering procedures
1-3. Misalignment of workpiece lens
1-4. Structures of molding die and lens
1-5. Configuration of positioning unit
1-6. Centering method
1-7. Effects of the first embodiment

### 1-8. Variation and so on

2. The second embodiment
2-1. Structures of molding die and lens
2-2. Structure of positioning unit
2-3. Centering method
2-4. Effects of the second embodiment

### 2-5. Variation and so on

3. The third embodiment
3-1. Structures of molding die and lens
3-2. Structure of positioning unit
3-3. Centering method
3-4. Effects of the third embodiment

### 3-5. Variation and so on

### <1. The First Embodiment>

### (1-1. Overview of Centering Apparatus)

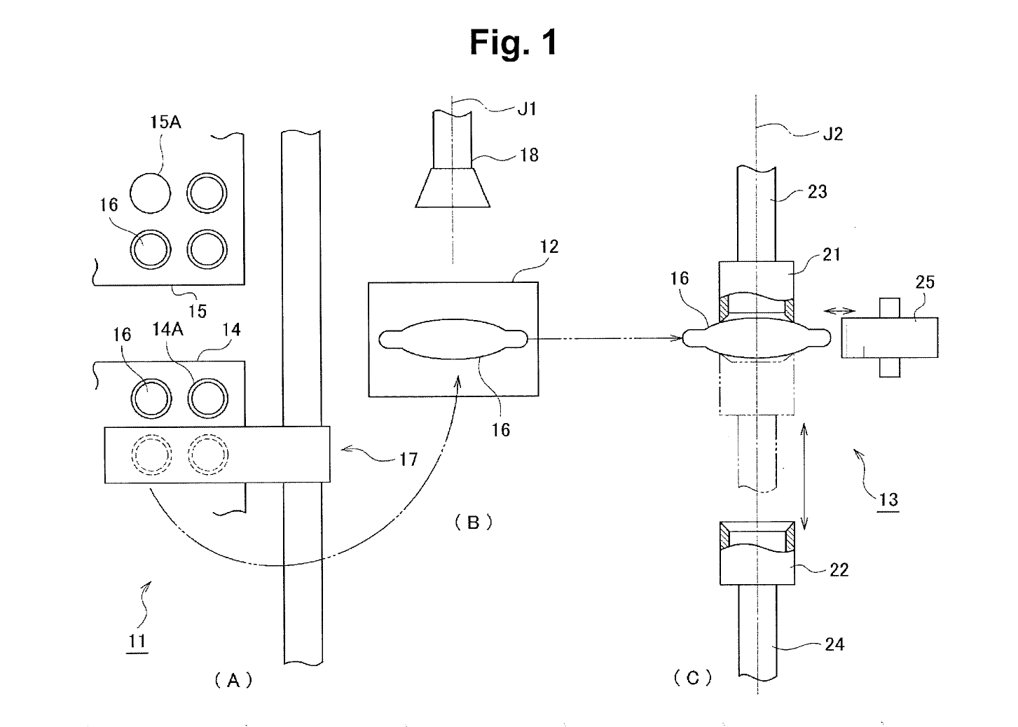

FIG. 1 is a schematic diagram illustrating an overview of a centering apparatus related to the first embodiment of the present invention.

The centering apparatus primarily has three processing portions. A first processing portion is a lens supply/storage part 11. A second processing portion is a lens positioning part 12. A third processing portion is a lens processing part 13. The centering apparatus has an automatic mode for operating in accordance with a control program incorporated into the control system of the centering apparatus beforehand, and a manual mode for operating in accordance with instructions inputted from outside. The present invention can be applied to either mode of operation.

The lens supply/storage part 11, as shown in FIG. 1(A), is the processing portion for supplying a lens prior to centering and for storing a lens subsequent to centering. A tray 14 for storing pre-centering lenses and a tray 15 for storing post-centering lenses are installed in the lens supply/storage portion 11. A lens 16 stored in tray 14 thereof constitutes the workpiece lens. The workpiece lens may be either a spherical lens or an aspherical lens. A plurality of lens pockets 14A is provided in the tray 14 at a fixed array pitch. A plurality of lenses 16 are stored in the plurality of lens pockets 14A respectively, with the front and rear sides of each of the lenses 16 being oriented in the same way. Each lens pocket 14A is formed in a cross-section concave shape, and pre-centering lenses 16 are stored in the lens pockets 14A. A plurality of lens pockets 15A is formed in tray 15 as well, and post-centering lenses 16 are stored in these lens pockets 15A.

A lens carrier apparatus 17 is also provided in the lens supply/storage part 11. The lens carrier apparatus 17 is configured to hold a lens 16 with an absorbing part (not shown in the drawing), and to perform lens supply operations and storage operations. In a lens supply operation, the lens carrier apparatus 17 is configured to fetch a pre-centering lens 16 from a lens pocket 14A in tray 14, and to supply the lens 16 to the next process (lens positioning process). In the lens storage operation, the lens carrier apparatus 17 is configured to receive a post-centering lens 16 from the previous process, and to store the lens 16 in a lens pocket 15A of tray 15. Changes occur in the outside diameter and shape of a lens between the pre-centering lens 16 and the post-centering lens 16, but these changes have been simplified in FIG. 1(A). The viewing direction differs for FIGS. 1(A), 1(B) and 1(C).

The lens positioning part 12, as shown in FIG. 1(B), is the processing portion for positioning a lens 16 supplied from the lens supply/storage part 11 by the lens carrier apparatus 17 prior to supplying this lens 16 to the lens processing part 13. The lens positioning part 12 will be explained in detail in a subsequent paragraph. A lens 16 that has been positioned by the positioning part 12 is held in a lens holder 18 provided in a transfer arm not shown in the drawing, and is supplied in this state to the lens processing part 13 by the movement of the transfer arm. In the lens processing part 13, when the lens 16 being held in the lens holder 18 is transferred to a holder 21 described further below, the central axis Jo of the lens 16 is aligned with the central axis J2 of the holder 21.

The lens processing part 13, as shown in FIG. 1(C), is the processing portion for performing centering for a lens (workpiece lens) 16 that was molded using the molding die (will be explained in detail further below). A pair of holders 21, 22 of a bell clamp system is provided in the lens processing part 13. The holders 21, 22 are formed in the shape of cylinders that are open on one side. The holder 21 is provided at the tip of a rotating shaft part 23, and the holder 22 is provided at the tip of a rotating shaft part 24. The pair of holders 21, 22 is arranged coaxially having the same central axis J2. The rotating shaft parts 23, 24 are also arranged mutually coaxially having the same central axis J2 as the pair of holders 21, 22. The rotating shaft parts 23, 24 are rotatably provided having a motor or the like as a driving source. The one rotating shaft part 24 is provided so as to be able to move in a direction parallel to the central axis J2. In addition, a grinding wheel 25 is provided in the lens processing part 13. The grinding wheel 25 is rotatably provided having a motor or the like as a driving source. The grinding wheel 25 is provided so as to be able to move in a direction orthogonal to the central axis J2. The grinding wheel 25 is provided so as to be able to used when processing a planar part of the lens 16 and/or when processing steps in the lens 16, which will be explained further below, and so as to be able to move in a direction parallel to the central axis J2.

### (1-2. Centering Procedures)

The procedures when centering a lens 16 using the centering apparatus comprising the above-described configuration will be briefly explained.

First, the centering apparatus is configured to hold a lens 16 stored in the tray 14 using the absorbing part of the lens carrier apparatus 17, and thereafter, to supply the lens 16 to the lens positioning part 12 by driving the lens carrier apparatus 17. Next, the centering apparatus is configured to use the lens positioning part 12 to position the lens 16 (will be explained in detail further below). Next, the centering apparatus is configured to use the lens holder 18 to hold the lens 16 in the state in which it was positioned by the positioning part 12, and thereafter, to supply the lens 16 to the lens processing part 13 by moving the not-shown transfer arm.

In the lens processing part 13, first, the lens 16 being held by the lens holder 18 is arranged at a prescribed distance from and in the direction facing toward the open end of the one holder 21. The central axis Jo of the lens 16 is aligned with the central axis J2 of the holder 21 at this time. The other holder 22, prior to the lens 16 supply operation by the lens holder 18, is configured to transition to a retracted state so as not to interfere therewith.

Next, the lens 16 that had been held by the lens holder 18 is brought into close proximity to the open end of the holder 21 by the movement of the not-shown transfer arm. Then, when the one optical surface of the lens 16 comes in contact with the open end of the holder 21, air is suctioned through the inside of the rotating shaft part 23, and the lens 16 is clamped and held to the holder 21 by the force of the suction.

Next, the centering apparatus, after separating the lens holder 18 from the lens 16, is configured to retract the lens holder 18 from between the pair of holders 21, 22. Next, the centering apparatus is configured to bring the other holder 22 into close proximity to the one holder 21, thereby allowing the other optical surface of the lens 16 to come into contact with the open end of the holder 22. This results in the lens 16 being held between the pair of holders 21, 22.

Next, the centering apparatus, using the driving of a not-shown motor or the like, is configured to integrally rotate the pair of holders 21, 22 with the rotating shafts 23, 24 while supplying a lubricant or the like from a not-shown nozzle to the lens 16 being held between the pair of holders 21, 22. At this time, when the optical axis Jo of the lens 16 is not aligned with the central axis J2, or when there is room to bring the optical axis Jo of the lens 16 into closer proximity to the central axis J2, the lens 16 is made to slide so as to align these axes.

Next, the centering apparatus, after increasing the lens 16 holding pressure by the pair of holders 21, 22 to a prescribed pressure (enough pressure that the lens will not become misaligned during centering), is configured to bring the grinding wheel 25 into close proximity to the lens 16 thereby allowing the grinding wheel 25 to make contact with the outer circumference of the lens 16. This enables the lens 16 to be processed by the grinding wheel 25 in a state in which the optical axis Jo of the lens 16 has been aligned with the central axis J2 of the pair of holders 21, 22.

Thereafter, the centering apparatus is configured to separate the grinding wheel 25 from the lens 16 once the outer circumference of the lens 16 has been processed to a prescribed dimension and shape. Next, the centering apparatus, after separating the holder 22 from the lens 16, is configured to allow the lens holder 18 to advance over the central axis J2. Next, the centering apparatus is configured to deliver the lens 16 from the holder 21 to the lens holder 18, and thereafter, to supply the lens 16 to the lens positioning part 12 by moving the not-shown transfer arm.

Next, the centering apparatus is configured to use the absorbing part (not shown in the drawing) of the lens carrier apparatus 17 to hold the processed lens 16 that has been placed in the lens positioning part 12. Next, the centering apparatus is configured to move the lens 16 to the lens supply/storage part 11 by driving the lens carrier apparatus 17, and then to store the lens 16 in an empty lens pocket 15A of the tray 15.

The basic procedures when centering a single lens 16 have been explained here in chronological order, but a plurality of lenses 16 is actually centered in a continuous manner. In this case, the lens 16 supply/storage operation in the lens supply/storage part 11 and the lens 16 positioning operation in the lens positioning part 12 are performed in parallel during the lens 16 processing operation of the lens processing part 13.

### (1-3. Misalignment of Workpiece Lens)

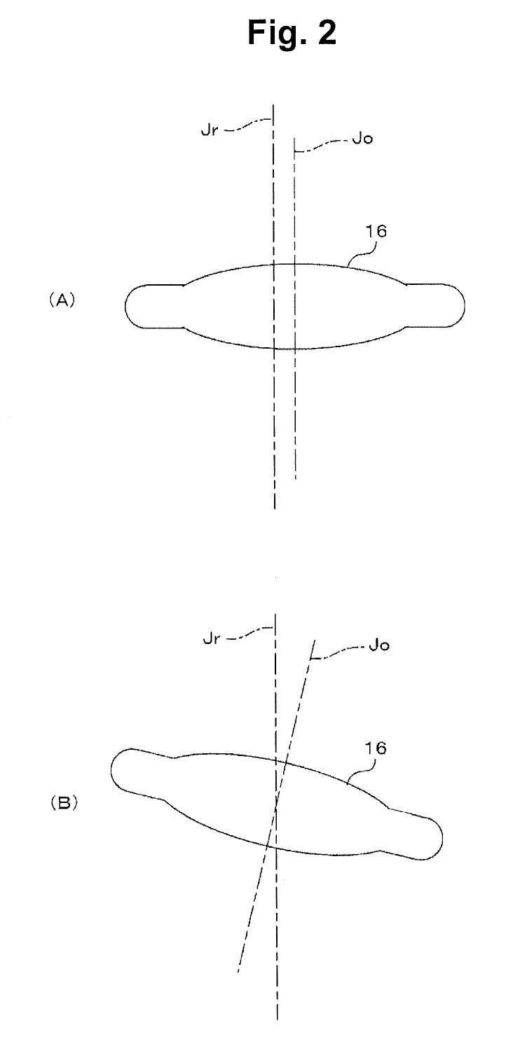

There are two modes of misalignment for a lens 16 that is targeted for centering. One is a mode of misalignment in which the optical axis (central axis) Jo of the lens 16 shifts parallelly with respect to the reference axis Jr (hereinafter referred to as “shift misalignment”) as shown in FIG. 2(A). The other one is a mode of misalignment in which the optical axis Jo of the lens 16 has tilted in respect to the reference axis Jr (hereinafter referred to as “tilt misalignment”) as shown in FIG. 2(B). Actually, in a lens 16 misalignment, shift misalignment and tilt misalignment often occur at the same time (compound misalignment).

### (1-4. Structures of Molding Die and Lens)

Next, the structures of the molding die, used in molding the workpiece lens, and the lens will be explained.

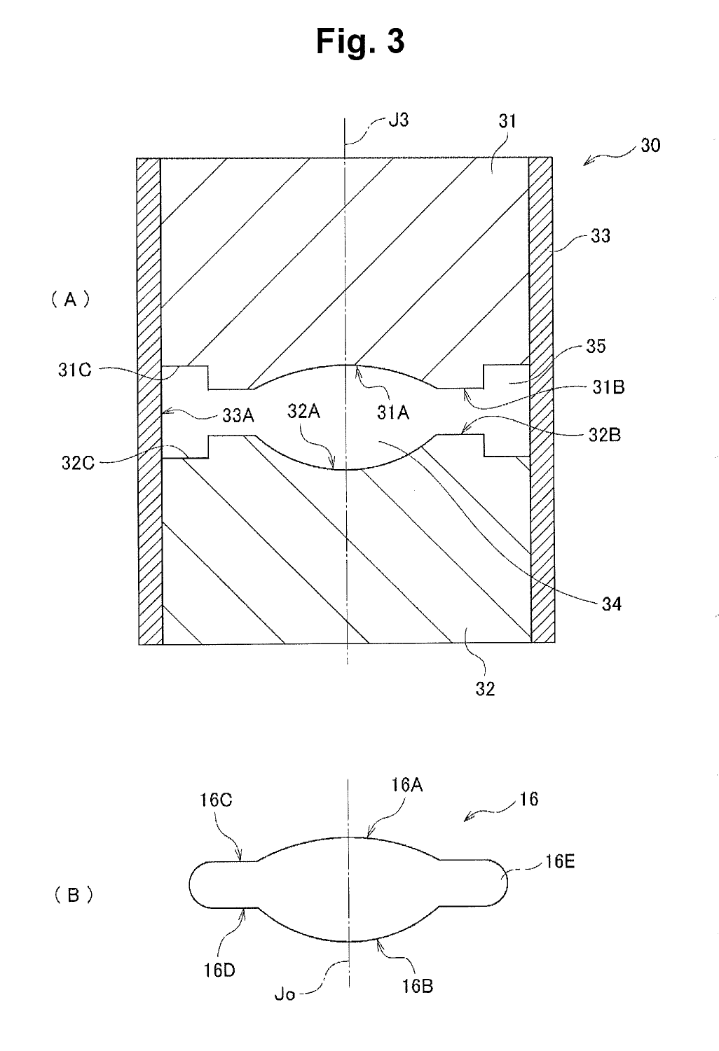

FIG. 3 is a cross-sectional view showing the structure of a molding die and the structure of a lens related to the first embodiment of the present invention. Specifically, FIG. 3(A) is a cross-sectional view showing the structure of a molding die related to the first embodiment of the present invention, and FIG. 3(B) is a cross-sectional view showing the structure of a lens molded using this molding die.

The molding die 30 is configured to form the target workpiece lens by press molding. The molding die 30 comprises an upper die 31, a lower die 32, and a body die 33.

Molding surfaces 31A, 31B are provided in the upper die 31, and molding surfaces 32A, 32B are provided in the lower die 32 opposed thereto. The molding surface 31A is the surface for molding the one optical surface 16A of the lens 16, and the molding surface 32A is the surface for molding the other optical surface 16B of the lens 16. The molding surfaces 31A, 32A correspond to an example of the “first molding surface”, and are arranged facing one another via a molding space 34 during press molding. The molding surfaces 31A, 32A are formed such that the center of the curved surfaces thereof (the surfaces corresponding to either the spherical surfaces or the aspherical surfaces formed by the optical surfaces of the lens) are aligned with the central axis J3 of the molding die 30. The molding surfaces 31A, 32A are concavely formed in accordance with the optical surfaces 16A, 16B of the lens 16 corresponding thereto. In the present specification, the “molding surface”, for example, signifies the surface of the molding die with which the glass material constituting the molding material comes in contact during press molding, and has the same meaning in the embodiments that follow as well.

The molding surface 31B is the surface for molding the planar part 16C extending in the radial direction from the outer peripheral edge of the optical surface 16A of the lens 16. The molding surface 32B is the surface for molding the planar part 16D extending in the radial direction from the outer peripheral edge of the optical surface 16B of the lens 16. The molding surfaces 31B, 32B correspond to an example of the “second molding surface”, and are arranged opposing one another at the time of press molding. The molding surface 31B is formed on the outer side of the molding surface 31A, and the molding surface 32B is formed on the outer side of the molding surface 32A. The molding surfaces 31B, 32B are formed by forming planar surfaces that are orthogonal to the central axis J3 of the molding die 30.

In addition, runoff parts 31C, 32C are formed in both the upper die 31 and the lower die 32. The runoff parts 310, 32C forma runoff space 35 for avoiding interference with a free surface part 16E that bulges outward when the lens is press molded using the molding die 30. The runoff space 35 is interlinkingly formed with the molding space 34. In this embodiment, an example is given in which runoff parts 31C, 32C are formed, but the runoff parts 31C, 32C do not have to be provided, in which case, the runoff parts 31C, 32C may be planar surfaces that are continuations of the molding surfaces 31B, 32B, or may be curved surfaces that are continuations of the molding surfaces 31B, 32B.

The body die 33 is configured to coaxially house the upper die 31 and the lower die 32. The body die 33 is formed in a cylindrical shape. An inner circumferential surface 33A of the body die 33 is configured to mark off the upper die 31 runoff part 31C and the lower die 32 runoff part 32C, and the runoff space 35. Therefore, the inner circumferential surface 33A of the body die 33 is configured to face the runoff space 35. The body die 33 is configured so that the upper die 31 and the lower die 32 can move in and out in a direction parallel to the central axis J3. However, in the state in which the upper die 31 and the lower die 32 are inserted into the body die 33, the inside diameter of the body die 33 is configured to the outside diameters of the upper die 31 and the lower die 32 so that practically no clearance forms between the outer circumferential surface of the upper die 31 and the inner circumferential surface 33A of the body die 33, and also practically no clearance forms between the outer circumferential surface of the lower die 32 and the inner circumferential surface 33A of the body die 33.

In a case where a lens is molded using the molding die 30 comprising the configuration described above, the centering apparatus is configured to sandwich the glass material between the upper die 31 and the lower die 32 and to house the glass material-filled dies 31, 32 in the body die 33, and thereafter to apply a prescribed temperature and a prescribed pressure to the glass material, thereby softening the glass material to press mold the lens 16. The optical surfaces 16A, 16B of the lens 16 are molded at this time by the molding surface 31A of the upper die 31 and the molding surface 32A of the lower die 32. The planar parts 16C, 16D of the lens 16 are molded at the same time by the molding surface 31B of the upper die 31 and the molding surface 32B of the lower die 32. In addition, surplus glass material flows into the runoff space 35 formed by the upper die 31 runoff part 31C and the lower die 32 runoff part 32C in accordance with being pressed by the molding surfaces 31A, 32A of the molding die 30, and a free surface part 16E is formed on the outer sides of the planar parts 16C, 16D of the lens 16. The optical surfaces 16A, 16B of the lens 16 formed at this time may be either spherical surfaces or aspherical surfaces, but in either case, are molded in a state in which the optical axis Jo of the lens 16 is aligned with the central axis J3 of the molding die 30. In the present specification, the free surface part 16E is not formed by the glass material absorbing the heat and swelling, but rather is formed by the glass material flowing and changing shape as a result of press molding.

### (1-5. Configuration of Positioning Unit)

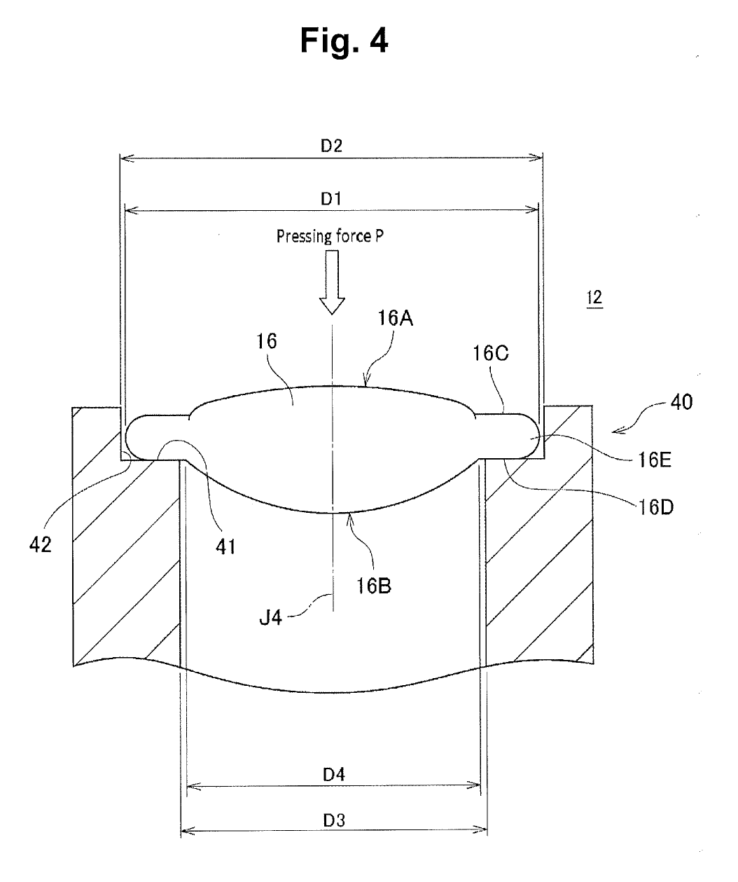

FIG. 4 is a schematic cross-sectional view showing an example of the configuration of a positioning unit related to the first embodiment of the present invention.

The positioning unit comprises a positioning member 40 is configured to enable the positioning of a lens 16 prior to mounting the lens 16 in the holder 21 during the above-described centering procedures. The positioning member 40 is formed in a cylindrical shape. Precision is achieved mechanically in the centering apparatus by positioning the optical axis Jo of the lens 16 with respect to a reference axis (central axis) J4 of the positioning member 40 so that when the positioned lens 16 is supplied to the lens processing part 13 the optical axis Jo of the lens 16 is aligned with the central axis J2 of the pair of holders 21, 22.

The top end of the positioning member 40 is formed in the shape of a step with an inside diameter D2 that is larger than the outside diameter D1 of the lens 16. The bottom portion of this step is a guidance part 41. The guidance part 41 is formed by forming a planar surface that is orthogonal to the reference axis J4 of the positioning member 40. Also, the diameter (bore diameter) D3 of the inner peripheral edge of the guidance part 41 is configured larger than the diameter D4 of the outer peripheral edge of the optical surface 16B of the lens 16.

### (1-6. Centering Method)

Next, a centering method related to the first embodiment of the present invention will be explained. In this centering method, a positioning unit of the above-described configuration is used. Also, explanations that duplicate those of the centering procedures described hereinabove will be omitted here as much as possible.

First, the centering apparatus is configured to supply a lens 16 to the lens positioning part 12 from the lens supply/storage part 11 using the lens carrier apparatus 17 as described hereinabove. The lens 16 is positioned at this time using the positioning member 40 of the above-described configuration. Specifically, the lens 16 is positioned as follows.

First, the centering apparatus is configured to carry the lens 16 held by the absorbing part (not shown in the drawing) of the lens carrier apparatus 17 to the lens positioning part 12. The centering apparatus is configured to arrange the lens 16 directly above the positioning member 40 at this time. Next, the centering apparatus is configured to place the lens 16 in the guidance part 41 of the positioning member 40 by lowering the lens 16 held by the absorbing part of the lens carrier apparatus 17 parallel to the direction of the reference axis J4 of the positioning member 40. The centering apparatus is configured to release the hold on the lens 16 by the absorbing part at this stage and to separate the absorbing part from the lens 16. When the lens 16 is transferred to the positioning member 40 like this, the planar part 16D of the lens 16 is configured to come in contact with the guidance part 41 of the positioning member 40. Pressure P is applied to the lens from above the lens 16 at this time, thereby enabling the planar part 16D of the lens 16 to more reliably make contact with the guidance part 41 of the positioning member 40. A clearance (for example, a clearance of 0.002 to 0.2 mm on one side) corresponding to the dimensional difference between the above-described inside diameter D2 and outside diameter D1 is formed between the free surface part 16E of the lens 16 and the upper inner circumferential surface 42 of the positioning member 40 opposed thereto.

By placing the lens 16 on the positioning member 40 like this, the optical axis Jo of the lens 16 is positioned with respect to the reference axis J4 of the positioning member 40. Specifically, the optical axis Jo of the lens 16 is positioned in a no-tilt state (a parallel state) with respect to the reference axis J4 of the positioning member 40. Therefore, when a lens 16 positioned by the positioning member 40 is supplied to the lens processing part 13, the lens 16 can be mounted to the holder 21 such that the optical axis Jo of the lens 16 is parallel to the central axis J2 of the holder 21.

When placing the lens 16 in the positioning member 40, the planar part 16D may come in contact with the guidance part 41 using only the weight of the lens 16 itself.

Next, the centering apparatus is configured to use the lens holder 18 provided in the not-shown transfer arm to hold the lens 16 in the positioned state in the lens positioning part 12. At this time, the lens holder 18, for example, is configured to approach the lens 16 so as not to alter the position of the lens 16. Then, when the bottom end of the lens holder 18 makes contact with the optical surface 16A of the lens 16, the lens holder 18 is configured to hold the lens 16 by suctioning air.

Next, the centering apparatus is configured to use the movement of the transfer arm to supply the lens 16 to the lens processing part 13. In the lens processing part 13, the centering apparatus is configured to first arrange the lens 16 being held by the lens holder 18 at a prescribed distance from and in the direction facing toward the open end of the one holder 21. At this time, the centering apparatus is configured to arrange the lens 16 so that the central axis Jo of the lens 16 is aligned with the central axis J2 of the holder 21. The other holder 22 is configured to transition to a retracted state prior to the lens 16 supply operation by the lens holder 18 so as not to interfere therewith.

Next, the centering apparatus is configured to allow the lens 16 held by the lens holder 18 to come into close proximity to the open end of the holder 21 by moving the not-shown transfer arm. Then, when the optical surface 16B of the lens 16 comes in contact with the open end of the holder 21, the centering apparatus is configured to hold the lens 16 in the holder 21 by suctioning air through the inside of the rotating shaft part 23, and, in addition, to separate the lens holder 18 from the lens 16 by using the lens holder 18 to stop the suctioning of the air. Thus, the centering apparatus is configured to mount the lens 16 positioned by the positioning member 40 in the holder 21 so that the state of the optical axis Jo of the lens 16 with respect to the central axis J2 of the holder 21 is the same as the state of the optical axis Jo of the lens 16 with respect to the reference axis J4 of the positioning member 40.

Next, the centering apparatus is configured to retract the lens holder 18 from between the pair of holders 21, 22, and thereafter to bring the other holder 22 into close proximity to the one holder 21, and to use this approach to bring the open end of the holder 22 into contact with the optical surface 16A of the lens 16. This enables the lens 16 to be held between the pair of holders 21, 22. The one holder 21 and the other holder 22 are arranged having a common central axis J2. Therefore, the lens 16 is held therebetween in a state in which the central axis (J2) of the one holder 21 and the central axis (J2) of the other holder 22 are substantially aligned.

Next, the centering apparatus is configured to use the driving of a not-shown motor or the like to integrally rotate the pair of holders 21, 22 with the rotating shaft parts 23, 24 while supplying a lubricant or the like from a not-shown nozzle to the lens 16 being held between the pair of holders 21, 22. At this time, when the optical axis Jo of the lens 16 is not aligned with the central axis J2, or when there is room to bring the optical axis Jo of the lens 16 into closer proximity to the central axis J2, the lens 16 is made to slide so as to align these axes. Therefore, in a case where the optical axis Jo of the lens 16 has become shift-misaligned with respect to the central axis J2 of the holders 21, 22, the sliding corrects the shift-misalignment. The subsequent processing using the grinding wheel 25 and the procedures up to the storing of the post-processing lens 16 in the tray 15 are the same as described hereinabove.

Regarding shift-misalignment, besides correcting for shift-misalignment using the above-described sliding, for example, the centering apparatus may be configured to also correct for shift-misalignment by searching out the position where the lens 16 was in closest proximity to the holder 21 while bringing the lens 16 held in the lens holder 18 into contact with the holder 21 and suitably moving the lens 16 slightly in a two-dimensional direction orthogonal to the central axis J2.

### (1-7. Effects of the First Embodiment)

In the first embodiment of the present invention, when centering a workpiece lens, the optical axis Jo of the lens 16 is positioned with respect to the reference axis J4 of the positioning member 40 using the planar part 16D of the lens 16, and the positioned lens 16 is mounted in the holder 21 thereafter, thereby making it possible to mount the lens in the holder 21 with high positional precision. Specifically, it is possible to mount the lens 16 in the holder 21 without causing the optical axis Jo of the lens 16 to tilt-misalign with respect to the central axis J2 of the holder 21. Therefore, when mounting the lens 16 to the holder 21 or holding the lens 16 between the pair of holders 21, 22, lens 16 displacement (the displacement caused by the workpiece lens being shifted from the regular position when mounted) can be kept low.

Also, since tilt-misalignment is corrected beforehand, it is possible to keep lens 16 displacement lower than using sliding when the lens 16 being held between the pair of holders 21, 22 is rotated to correct both shift-misalignment and tilt-misalignment simultaneously. Therefore, it is possible to effectively prevent lens 16 damage caused by rubbing against the pair of holders 21, 22, and possibly to improve post-centering decentration precision. In a case where an anti-reflective film has been formed on the optical surfaces 16A, 16B of the lens 16, it is also possible to effectively prevent damage to the antireflective film. The effects are obtained when the lens 16 is either a spherical lens or an aspherical lens, but, better effects can be expected to be obtained in the case of an aspherical lens in particular since the aspherical lens is more prone to damage caused by rubbing against the holders 21, 22 than the spherical lens.

### (1-8. Variation and so on)

In this embodiment, the planar part 16D of the lens 16 is used when positioning the optical axis Jo of the lens 16, but the present invention is not limited thereto, and the planar part 16C of the lens 16, which is on the opposite side, may be used. The planar parts 16C, 16D of the lens 16 do not necessarily have to have flat surfaces; for example, there can be irregularities in the surface as long as the planar part is either entirely or partially planar.

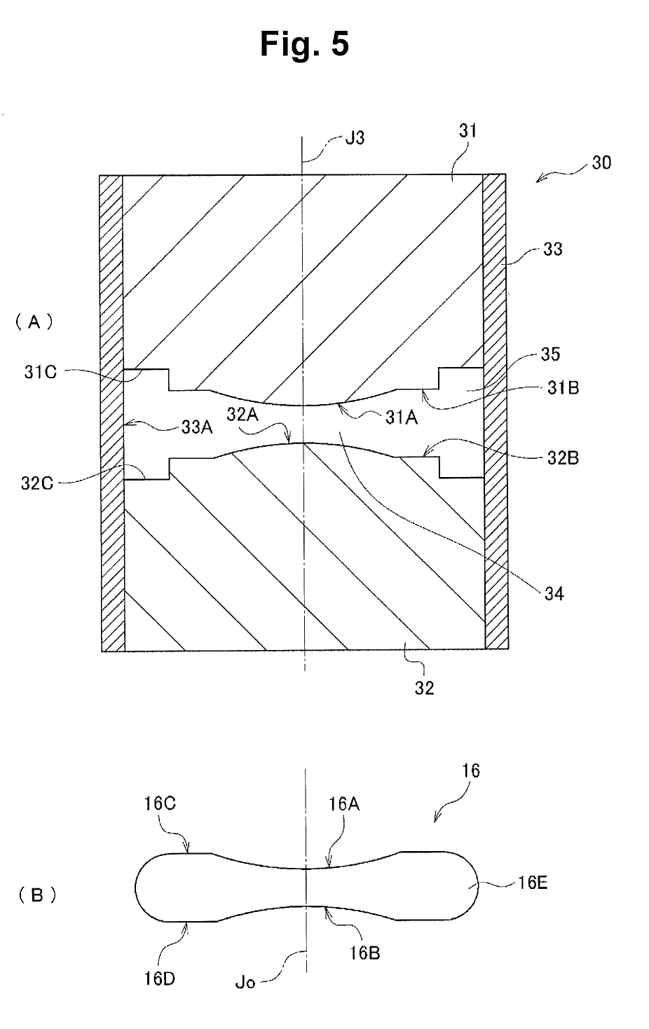

Regarding the structures of the molding die and the lens, for example, the structures shown in FIGS. 5(A), 5(B) may also be applied. In the molding die 30 shown in the drawing, the following points differ from the molding die 30 shown in FIG. 3(A) above. That is, in the molding die 30 shown in FIG. 3(A) above, both the molding surface 31A of the upper die 31 and the molding surface 32A of the lower die 32 are formed using a concave surface. Therefore, the optical surfaces 16A, 16B of the lens 16 obtained by press molding are both convex surfaces as shown in FIG. 3(B). By contrast, in the molding die 30 shown in FIG. 5(A), both the molding surface 31A of the upper die 31 and the molding surface 32A of the lower die 32 are formed with convex surfaces. Therefore, the optical surfaces 16A, 16B of the lens 16 obtained by press molding have concave surfaces as shown in FIG. 5(B). The other portions of the molding die 30 and the lens 16 have the same structures. The optical surfaces of the lens can be freely changed to a convexo-concave combination.

The planar part 16C (or 16D) used in positioning the lens 16 does not necessarily have to be planar in the plane orthogonal to the optical axis Jo of the lens 16. The reason for this is as follows. That is, the angle formed by the optical axis Jo of the lens 16 and the planar part 16C (or 16D) does not have to be a right angle, and in a case where the angle is known beforehand from the standpoint of lens design, it is possible to correct tilt-misalignment using the lens positioning part 12 the same as above, by forming a guidance part 41 on the positioning member 40 tailored to the angle.

### <2. The Second Embodiment>

Next, a second embodiment of the present invention will be explained. The overview of the centering apparatus is the same as that for the first embodiment described above, and as such, the explanation will be omitted.

### (2-1. Structures of Molding Die and Lens)

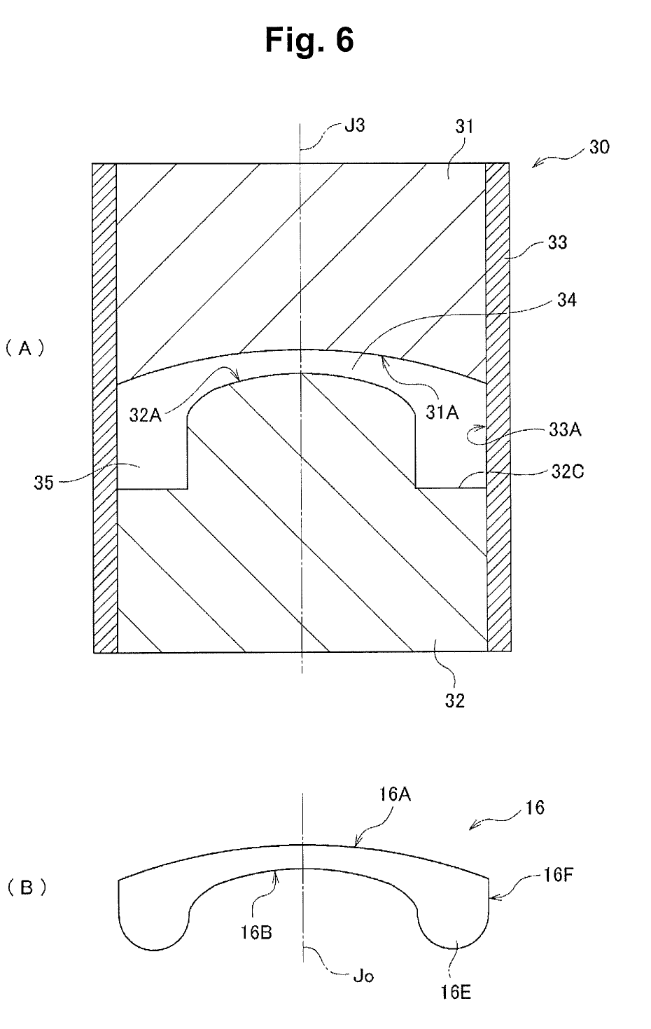

FIG. 6 is a cross-sectional view showing the structure of a molding die and the structure of a lens related to the second embodiment of the present invention. Specifically, FIG. 6(A) is a cross-sectional view showing an example of the structure of the molding die related to the first embodiment of the present invention, and FIG. 6(B) is a cross-sectional view showing an example of the structure of a lens molded using the molding die. Regarding the reference symbols of the respective parts noted in the drawings, like reference symbols will be assigned to portions corresponding to the embodiment described hereinabove.

The molding die 30 is configured to form a workpiece lens using press molding, and comprises an upper die 31, a lower die 32, and a body die 33. A molding surface 31A is provided in the upper die 31, and a molding surface 32A is provided in the lower die 32 opposed thereto. The molding surface 31A is the surface for molding the one optical surface 16A of the lens 16, and the molding surface 32A is the surface for molding the other optical surface 16B of the lens 16. The molding surface 31A is formed having practically the same diameter as the outside diameter of the upper die 31. The molding surface 32A is formed having a smaller diameter than the outside diameter of the lower die 32. The molding surfaces 31A, 32A are arranged facing one another having the molding space 34 therebetween at press molding time. The molding surfaces 31A, 32A are formed such that the centers of the curved surfaces thereof are aligned with the central axis J3 of the molding die 30. The molding surface 31A is formed having a concave surface tailored to the optical surface 16A of the lens 16, and the molding surface 32A is formed having a convex surface tailored to the optical surface 16B of the lens 16.

A runoff part 32C is formed in the lower die 32. The runoff part 32C is for forming a runoff space 35 for avoiding interference with a free surface part 16E that bulges outward on the bottom side when press molding a lens using the molding die 30. The runoff space 35 is interlinkingly formed with the molding space 34.

The body die 33 is configured to coaxially house the upper die 31 and the lower die 32. The body die 33 is formed in a cylindrical shape. The inner circumferential surface 33A of the body die 33 is formed parallel to the central axis J3 of the molding die 30. The cross-sectional shape of the inner circumferential surface 33A of the body die 33 is formed in a perfect circle having the central axis J3 of the molding die 30 in the center. The inner circumferential surface 33A of the body die 33 is configured to face both the molding space 34 and the runoff space 35. The inner circumferential surface 33A of the body die 33 facing the molding space 34 constitutes the surface for molding the outer peripheral surface 16F of the lens 16. In addition, the inner circumferential surface 33A of the body die 33 facing the runoff space 35 constitutes the surface for marking off the lower die 32 runoff part 32C and the runoff space 35. The body die 33 is configured so that the upper die 31 and the lower die 32 can move in and out in a direction parallel to the central axis J3. However, in the state in which the upper die 31 and the lower die 32 are inserted into the body die 33, the inside diameter of the body die 33 is configured to the outside diameters of the upper die 31 and the lower die 32 so that practically no clearance forms between the outer circumferential surface of the upper die 31 and the inner circumferential surface 33A of the body die 33, and also practically no clearance forms between the outer circumferential surface of the lower die 32 and the inner circumferential surface 33A of the body die 33.

In a case where a lens 16 is molded using the molding die 30 comprising the configuration described above, the centering apparatus is configured to sandwich the glass material between the upper die 31 and the lower die 32 and to house the glass material-filled dies 31, 32 in the body die 33, and thereafter to apply a prescribed temperature and a prescribed pressure to the glass material, thereby softening the glass material to press mold the lens 16. The optical surfaces 16A, 16B of the lens 16 are molded at this time by the molding surface 31A of the upper die 31 and the molding surface 32A of the lower die 32. The outer peripheral surface 16F of the lens 16 is molded simultaneously thereto by the inner circumferential surface 33A of the body die 33. In addition, surplus glass material bulges outward to the runoff space 35 formed by runoff part 32C of the lower die 32, thereby forming the free surface part 16E of the lens 16. The optical surfaces 16A, 16B of the lens 16 formed at this time may be either spherical surfaces or aspherical surfaces, but in either case, are molded in a state in which the optical axis Jo of the lens 16 is aligned with the central axis J3 of the molding die 30. The outer peripheral surface 16F of the lens 16 is molded coaxially and parallel to the central axis J3 of the molding die 30.

### (2-2. Configuration of Positioning Unit)

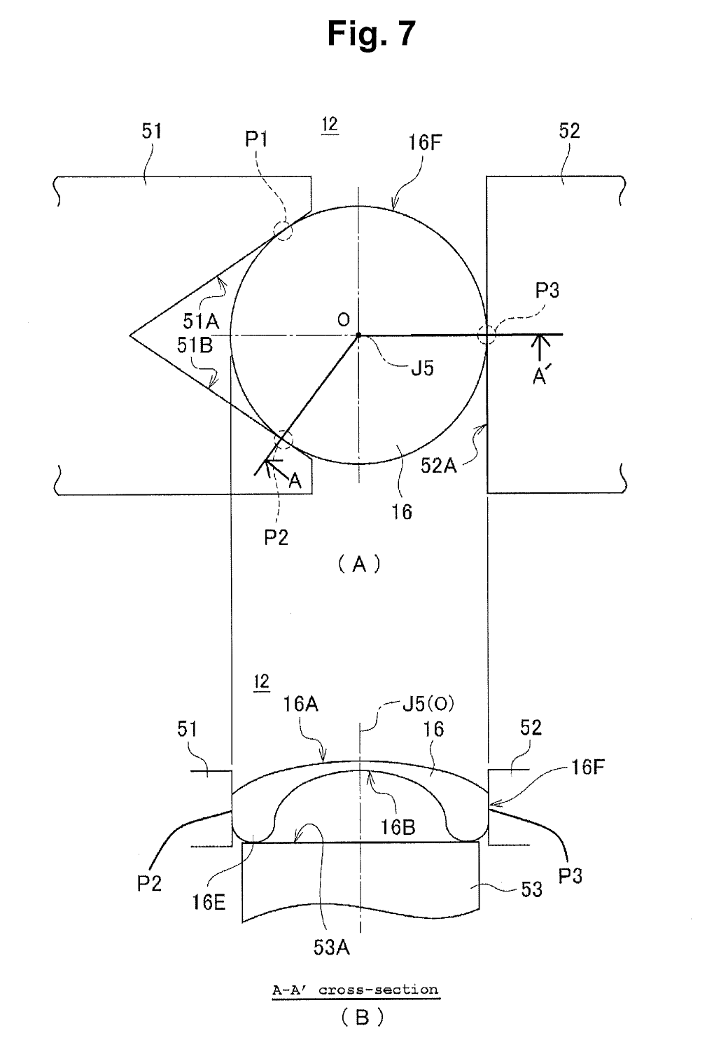

Next, the configuration of a positioning unit related to the second embodiment of the present invention will be explained using FIG. 7. FIG. 7 is a schematic diagram showing an example of the configuration of the positioning unit related to the second embodiment of the present invention. FIG. 7(A) shows a schematic diagram of a plan view, and (B) shows a schematic diagram of a side view (A-A′ cross-sectional view of FIG. 7(A)).

The positioning unit comprises a pair of lens holding members 51, 52 serving as positioning members configured to enable the positioning of a lens 16 prior to mounting the lens 16 in the holder 21 during the above-described centering procedures. The pair of lens holding members 51, 52 is for positioning the lens 16 so that the optical axis Jo of the lens 16 aligns with a reference axis J5 of the lens holding members 51, 52 by performing a closing operation in a state in which the lens 16 is arranged therebetween. Precision is achieved mechanically in the centering apparatus by positioning the optical axis Jo of the lens 16 with respect to the reference axis J5 used as a reference by the pair of lens holding members 51, 52 so that the optical axis Jo of the lens 16 is aligned with the central axis J2 of the pair of holders 21, 22 when the positioned lens 16 is supplied to the lens processing part 13.

The pair of lens holding members 51, 52 is provided so as to be able to move in one axial direction orthogonal to the reference axis J5. Also, the pair of lens holding members 51, 52 is provided so as to be able to move in directions approaching and moving away from one another. The direction in which the pair of lens holding members 51, 52 approach one another is the direction for performing the closing operation therefor, and the direction in which the pair of lens holding members 51, 52 move away from one another is the direction for performing an opening operation therefor.

Abutting reference surfaces 51A, 51B in the shape of a V are formed in the one lens holding member 51. A abutting reference surface 52A in the shape of a planar surface is formed in the other lens holding member 52. The abutting reference surfaces 51A, 51B, 52A correspond to an example of the “guidance part”. The V-shaped surface formed by the abutting reference surfaces 51A, 51B and the planar surface formed by the abutting reference surface 52A are arranged opposing one another in the direction in which the pair of lens holding members 51, 52 move.

A lens bearing member 53 is provided in the portion where the pair of lens holding members 51, 52 performs positioning. The lens bearing member 53 is configured to support the lens 16 from below. The outside diameter of the lens bearing member 53 is configured smaller than the outside diameter of the lens 16. The upper surface 53A of the lens bearing member 53 is arranged horizontally. The lens bearing member 53 is configured to support the lens 16 by bearing the bottom end of the free surface part 16E of the lens 16 on the upper surface 53A.

In FIG. 7(A), the pressure that the lens 16 is subjected to from both sides of the positioning member 51, 52 may be the same. That is, the positioning members 51, 52 are configured to exert the same force per unit of surface area from both the right and left sides.

In FIG. 7(A), when the lens 16 is being held therebetween, the valley (apex) of the V in the positioning member 51 and the reference axis J5 may be points of passage on the same line parallel to the direction of the holding pressure P.

Actually, the aperture angle of the V in the positioning member 51 is determined by the radius of the lens 16, but, for example, when the lens 16 is arranged between the positioning members 51, 52 and an attempt is made to hold the lens therebetween in a state in which the positioning members 51, 52 are separated, the lens 16 and the positioning members 51, 52 could come in contact at two points. Specifically, for example, the lens 16 and the positioning members 51, 52 could come in contact at a first point, indicated by P3, on the positioning member 52, and at a second point slightly to the lower right, indicated by P2, on the positioning member 51. In a case such as this, the centering apparatus is configured to bring the center 0 of the lens 16 closer to the reference axis J5 by opening the positioning members 51, 52, and thereafter, closing the positioning members 51, 52 (opening and closing the positioning members 51, 52 a plurality of times as needed), and after shifting the position of the lens 16 relative to the positioning members 51, 52 to a position where three-point support is possible, to hold the lens 16 therebetween. The pressure from the positioning members 51, 52 during the opening and closing operation at this time (the force applied per unit of surface area in the direction of the movement of the positioning member) can be adjusted as appropriate, and, for example, may be larger or smaller than the holding pressure P, may be the same as the holding pressure P, or may differ between the positioning members 51 and 52.

### (2-3. Centering Method)

Next, a centering method related to the second embodiment of the present invention will be explained. A positioning unit of the configuration described above is used in this centering method.

First, the centering apparatus is configured to supply a lens 16 to the lens positioning part 12 from the lens supply/storage part 11 using the lens carrier apparatus 17 as described above. The lens 16 is positioned at this time using the pair of lens holding members 51, 52 having the configuration described hereinabove. Specifically, the lens 16 is positioned as follows.

First, the centering apparatus is configured to carry the lens 16 held by the absorbing part (not shown in the drawing) of the lens carrier apparatus 17 to the lens positioning part 12. In so doing, the centering apparatus is configured to arrange the lens 16 directly above the lens bearing member 53. Next, the centering apparatus is configured to place the lens 16 on the upper surface 53A of the lens bearing member 53 by lowering the lens 16 being held by the absorbing part of the lens carrier apparatus 17 parallel to the direction of the reference axis J5. The centering apparatus is configured to release the hold on the lens 16 by the absorbing part at this stage, and to separate the absorbing part from the lens 16. When the lens 16 is transferred to the lens bearing member 53 like this, the free surface part 16E of the lens 16 comes in contact with the upper surface 53A of the lens bearing member 53.

Next, the centering apparatus is configured to cause the pair of lens holding members 51, 52 to close. In so doing, the abutting reference surfaces 51A, 51B of the lens holding member 51 and the abutting reference surface 52A of the lens holding member 52 are respectively configured to make contact with the outer peripheral surface 16F of the lens 16 at a total of three locations. Specifically, the abutting reference surface 51A is configured to make line contact with the outer peripheral surface 16F of the lens 16 at location P1, the abutting reference surface 51B is configured to make line contact with the outer peripheral surface 16F of the lens 16 at location P2, and the abutting reference surface 52A is configured to make line contact with the outer peripheral surface 16F of the lens 16 at location P3. Simultaneous thereto, the lens 16 is held between the pair of lens holding members 51, 52 using a prescribed pressure. This enables the optical axis Jo of the lens 16 to be positioned with respect to the reference axis J5. Specifically, the optical axis Jo of the lens 16 is positioned in a substantially aligned state with respect to the reference axis J5. The “substantially aligned state” described here, for example, refers to a state in which the lens optical axis Jo matches the tilt and shift of either the central axis J5 of the positioning members 51, 52 or the central axis J2 of the holder 21 to the extent that either the magnitude of reflection decentration or the magnitude of transmission decentration is held within a desired standard value. The reflection decentration or transmission decentration of the lens is defined by the amount of misalignment of either a reflected light image or a transmitted light image generated by the amount of misalignment (at least one of a shift-misalignment or a tilt-misalignment) of the optical axis of the lens surface when any of the lens outside diameter part, the lens optical surface part, or the lens planar part is used as the reference. The lens outside diameter part, the lens optical surface part, or the lens planar part is used as amounting reference part when assembling a lens barrel. Each of the lens outside diameter part, the lens optical surface part, or the lens planar part is a reference for lens reflection decentration or transmission decentration. Since centering is a process for forming, by a mechanical process, either a lens outside diameter part or a lens planar part that constitutes a reference for either lens reflection decentration or transmission decentration, when centering is performed, the centering should be done in a state in which the lens optical axis Jo and the central axis of the centering chuck or holder are aligned to the extent of being held within the norm for either reflection decentration or transmission decentration.

The optical axis Jo of the lens 16 has been positioned here by bringing the abutting reference surfaces 51A, 51B of the lens holding member 51 and the abutting reference surface 52A of the lens holding member 52 into contact with the outer peripheral surface 16F of the lens 16, but positioning may be performed by bringing the reference surface 52A into close proximity to the outer peripheral surface 16F of the lens 16 without making contact. However, in this case, it is desirable that the clearance between the respective abutting reference surfaces 51A, 51Bb 52a and the outer peripheral surface 16F of the lens 16 proximal thereto be within 0.002 mm on one side (a minimum value larger than 0).

Next, the centering apparatus is configured to supply the lens 16 positioned by the pair of lens holding members 51, 52 to the lens processing part 13 held as-is between the pair of lens holding member 51, 52. In the lens processing part 13, the centering apparatus is configured to first arrange the lens 16 being held between the lens holding members 51, 52 a prescribed distance away from and in a direction facing the open end of the one holder 21. In so doing, for example, the centering apparatus is configured to store the mechanical coordinates (spatial position coordinates) of the reference axis J5 of the pair of lens holding members 51, 52 and the central axis J2 of the holder 21 in the memory of the centering apparatus control system, and to use the control system to control the movement of the pair of lens holding members 51, 52 on the basis of the mechanical coordinates. This makes it possible for the optical axis Jo of the lens 16 being held between the pair of lens holding members 51, 52 to be positioned with respect to the central axis J2 of the holder 21. Prior to the operation for supplying the lens 16 by moving the lens holding members 51, 52, the other holder 22 is put on standby in a retracted state so as not to interfere therewith.

Next, the centering apparatus is configured to bring the lens 16 into close proximity to the open end of the holder 21 by moving the lens holding members 51, 52. Then, when the optical surface 16B of the lens 16 comes in contact with the open end of the holder 21, the centering apparatus is configured to cause the lens 16 to be held by the holder 21 by suctioning air through the inside of the rotating shaft part 23, and to perform an operation that causes the lens holding members 51, 52 to open. This enables the centering apparatus to mount the lens 16 that has been positioned by the lens holding members 51, 52 in the holder 21 so that the state of the optical axis Jo of the lens 16 with respect to the central axis J2 of the holder 21 is the same as the state of the optical axis Jo of the lens 16 with respect to the reference axis J5 of the lens holding members 51, 52.

Next, the centering apparatus is configured to retract the lens holding members 51, 52 from between the pair of holders 21, 22, and thereafter to bring the other holder 22 in close proximity to the one holder 21, and in accordance with this approach, to bring the open end of the holder 22 in contact with the optical surface 16A of the lens 16. This makes it possible to hold the lens 16 between the pair of holders 21, 22. Furthermore, the one holder 21 and the other holder 22 are arranged having the central axis J2 in common. Therefore, the lens 16 is held therebetween in a state in which the central axis (J2) of the one holder 21 is substantially aligned with the central axis (J2) of the other holder 22.

Next, the centering apparatus is configured to integrally rotate the pair of holders 21, 22 with the rotating shaft parts 23, 24 by the driving of a motor or the like not shown in the drawing, while supplying a lubricant or the like from a nozzle not shown in the drawing to the lens 16 held between the pair of holders 21, 22. At this time, when the optical axis Jo of the lens 16 is not aligned with the central axis J2, or when there is room to bring the optical axis Jo of the lens 16 into closer proximity to the central axis J2, the lens 16 is made to slide so as to align these axes. However, in this embodiment, the lens 16 is positioned prior to mounting the lens 16 in the holder 21 of the lens processing part 13 using the outer peripheral surface 16F of the lens 16 molded with high precision by the inner circumferential surface 33A of the body die 33. Therefore, even when the centering apparatus rotates the pair of holders 21, 22, the lens 16 is not damaged because the lens 16 almost never slides. Hypothetically, centering can similarly be performed with high decentration precision without damaging the lens 16 even in a case where the lens 16 has slid, because the optical axis Jo of the lens 16 is substantially aligned with the central axis J2. The subsequent processing using the grinding wheel 25 and the procedures up to storing the post-processing lens 16 in the tray 15 are the same as described hereinabove.

### (2-4. Effects of the Second Embodiment)

In the second embodiment of the present invention, since the optical axis of the lens 16 is positioned with respect to the reference axis J5 of the lens holding members 51, 52 using the outer peripheral surface 16F of the lens 16 when centering the workpiece lens, and thereafter, the positioned lens 16 is mounted in the holder 21, it is possible to mount the lens 16 in the holder 21 with high positional precision. Specifically, the lens 16 can be mounted in the holder 21 without causing a shift-misalignment and a tilt-misalignment of the optical axis Jo of the lens 16 with respect to the central axis J2 of the holder 21. Therefore, the displacement of the lens 16 can be kept to the minimum when mounting the lens 16 in the holder 21 or holding the lens 16 between the pair of holders 21, 22.

Furthermore, according to the centering apparatus of the second embodiment, both shift-misalignment and tilt-misalignment are corrected beforehand, thereby making it possible to hold the displacement of the lens 16 even lower than the centering apparatus of the first embodiment. Therefore, the centering apparatus of the second embodiment can effectively prevent damage to the lens 16 and/or damage to the antireflective film resulting from rubbing against the pair of holders 21, 22, and possibly improve post-centering decentration precision.

### (2-5. Variation and so on)

In this embodiment, both shift-misalignment and tilt-misalignment can be corrected by the pair of lens holding members 51, 52 using the outer peripheral surface 16F of the lens 16 molded by the inner circumferential surface 33A of the body die 33, but the present invention is not limited thereto, and either shift-misalignment alone or tilt-misalignment alone may be corrected using the outer peripheral surface 16F of the lens 16. In a case like this where only shift-misalignment or only tilt-misalignment is corrected, either the shift-misalignment or the tilt-misalignment may be corrected by making use of the sliding motion of the lens 16 that occurs in accordance with rotating the pair of holders 21, 22 while the lens 16 is being held therebetween the same as in the case of the first embodiment described hereinabove. In this case as well, since the displacement of the lens 16 is reduced more than in a case where both the shift-misalignment and the tilt-misalignment are corrected by sliding when rotating the lens 16 being held between the pair of holders 21, 22, the effects of preventing damage to the lens 16 and the antireflective film, and possibly improving post-centering decentration precision are achieved.

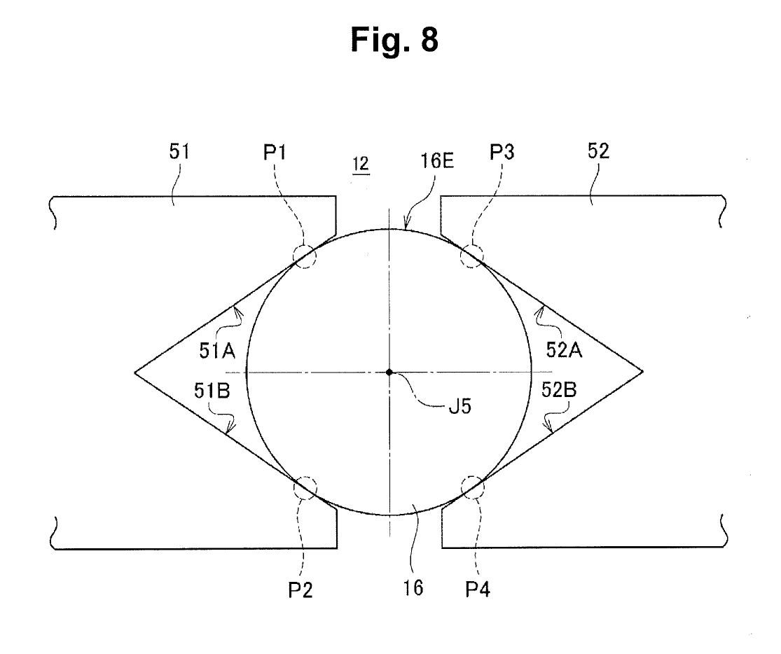

In this embodiment, as the configuration of the positioning member, abutting reference surfaces 51A, 51B in the shape of a V are provided in the one lens holding member 51, and a planar abutting reference surface 52A is provided in the other direction lens holding member 52 facing theretoward, but the present invention is not limited thereto. For example, as shown in FIG. 8, a configuration in which abutting reference surfaces 51A, 51B in the shape of a V are provided in the one lens holding member 51 and abutting reference surfaces 51A, 51B in the shape of a V are provided in the other lens holding member 52 facing theretoward may be used.

In a case where this configuration is used, the abutting reference surfaces 51A, 51B of the one lens holding member 51 and the abutting reference surfaces 52A, 52B of the other lens holding member 52 are respectively configured to make contact with the outer peripheral surface 16F of the lens 16 at a total of four places when the pair of lens holding members 51, 52 are subjected to a closing operation. Specifically, the abutting reference surface 51A is configured to make line contact with the outer peripheral surface 16F of the lens 16 at location P1, and the abutting reference surface 51B is configured to make line contact with the outer peripheral surface 16F of the lens 16 at location P2. In addition, the abutting reference surface 52A is configured to make line contact with the outer peripheral surface 16F of the lens 16 at location P3, and the abutting reference surface 52B is configured to make line contact with the outer peripheral surface 16F of the lens 16 at location P4. This makes it possible to position the optical axis Jo of the lens 16 with respect to the reference axis J5 the same as described hereinabove.

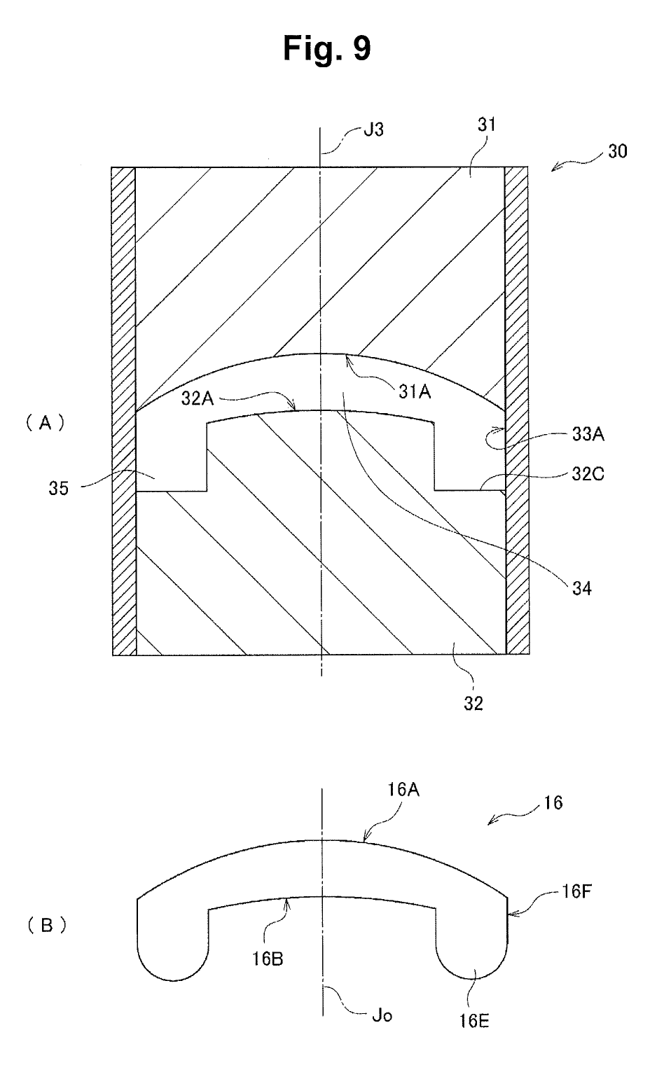

Furthermore, the structures of the molding die and the lens, for example, may also be used in the structures shown in FIGS. 9(A), 9(B). In the molding die 30 shown in the drawing, the following feature differs from the molding die 30 shown in FIG. 6(A) described hereinabove. That is, in the molding die 30 shown in FIG. 6(A) described hereinabove, the radius of curvature of the molding surface 31A of the upper die 31 is configured larger than the radius of curvature of the molding surface 32A of the lower die 32. Thus, an aspherical lens 16 obtained by press molding constitutes a concave meniscus lens as shown in FIG. 6(B). By contrast, in the molding die 30 shown in FIG. 9(A), the radius of curvature of the molding surface 31A of the upper die 31 is configured smaller than the radius of curvature of the molding surface 32A of the lower die 32. Thus, an aspherical lens 16 obtained by press molding constitutes a convex meniscus lens as shown in FIG. 9(B). The structures of the molding die 30 and the lens 16 are the same for the other portions. The optical surfaces of the lens can be freely changed to a convexo-concave combination.

### <3. The Third Embodiment>

Next, a third embodiment of the present invention will be explained. The overview of the centering apparatus is the same as in the first embodiment described hereinabove, and as such, the explanation will be omitted.

### (3-1. Structures of Molding Die and Lens)

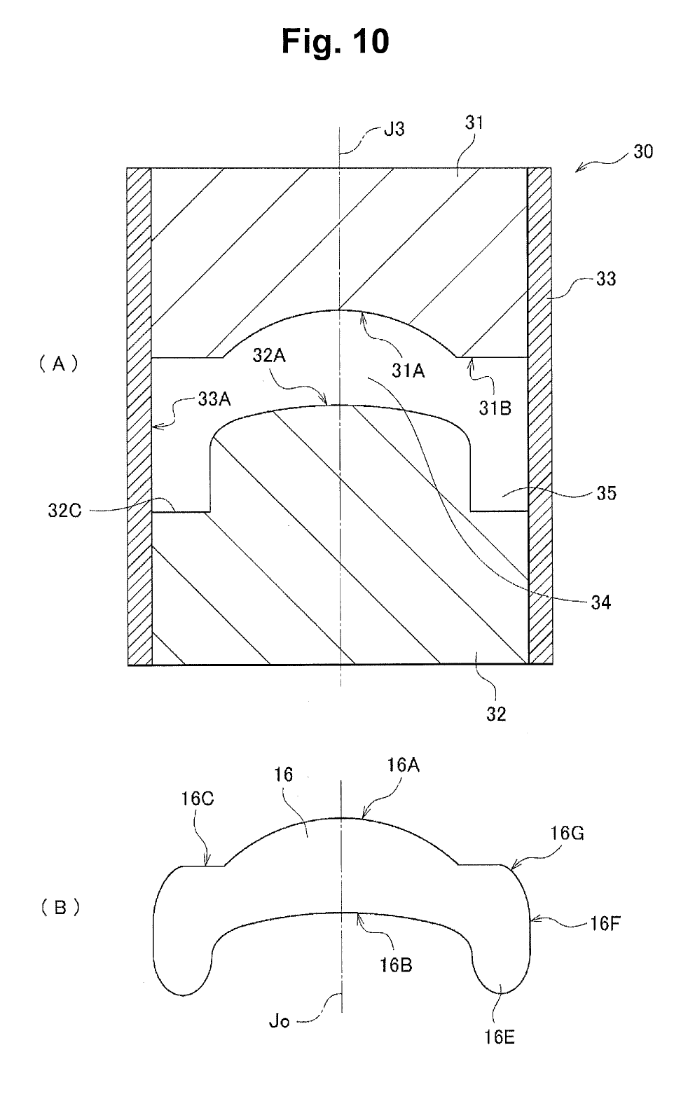

FIG. 10 is a diagram illustrating the structure of a molding die and the structure of a lens related to the third embodiment of the present invention. Specifically, FIG. 10(A) is a cross-sectional view showing an example of the structure of a molding die related to the third embodiment of the present invention, and (B) is a cross-sectional view showing an example of the structure of a lens molded using this molding die. Regarding the reference symbols of the respective parts noted in the drawings, like reference symbols will be assigned to portions corresponding to the embodiments described hereinabove. Also, in the embodiments described hereinabove, examples showing lenses having either a planar surface or an outer peripheral surface were given, but in this embodiment, a mode in which a convex meniscus lens has a planar surface and an outer peripheral surface will be explained. Features that differ from the embodiments described hereinabove will be explained below.

The molding die 30 is configured to form a workpiece lens using press molding, and comprises an upper die 31, a lower die 32, and a body die 33. A molding surface 31A and a molding surface 31B are provided in the upper die 31, and a molding surface 32A is provided in the lower die 32 opposing the molding surface 31A and the molding surface 31B of the upper die 31.

Molding surface 31A is configured to mold the one optical surface 16A of the lens 16, and molding surface 31B is configured to mold a planar surface 16C. Molding surface 32A is configured to mold the other optical surface 16B of the lens 16.

The molding surface 31A is formed with a smaller diameter than the outside diameter of the upper die 31. The molding surface 32A is formed with a diameter that is smaller than the outside diameter of the lower die 32. The molding surfaces 31A, 32A are arranged opposing one another at press molding time with a molding space 34 therebetween. The molding surfaces 31A, 32A are formed so that the centers of their respective curved surfaces align with the central axis J3 of the molding die 30. The molding surface 31A is concavely formed in accordance with the optical surface 16A of the lens 16, and the molding surface 32A is convexly formed in accordance with the optical surface 16B of the lens 16.

A runoff part 32C is formed in the lower die 32. The runoff part 32C is configured to form a runoff space 35 for avoiding interference with a free surface part 16E that bulges outward on the bottom side when press molding a lens using the molding die 30. The runoff space 35 is interlinkingly formed with the molding space 34.

The body die 33 is configured to coaxially house the upper die 31 and the lower die 32. The body die 33 is formed in a cylindrical shape. The inner circumferential surface 33A of the body die 33 is parallelly formed with the central axis J3 of the molding die 30. The inside shape of the inner circumferential surface 33A of the body die 33 is formed into a perfect circle having the central axis J3 of the molding die 30 in the center. The inner circumferential surface 33A of the body die 33 is configured to face toward both the molding space 34 and the runoff space 35. The inner circumferential surface 33A of the body die 33 facing the molding space 34 constitutes the surface for molding the outer peripheral surface 16F of the lens 16. The inner circumferential surface 33A of the body die 33 facing the runoff space 35 constitutes the surface for marking off the runoff part 32C of the lower die 32 and the runoff space 35. The body die 33 is configured so that the upper die 31 and the lower die 32 can move in and out in a direction parallel to the central axis J3. However, in the state in which the upper die 31 and the lower die 32 are inserted into the body die 33, for example, the clearance between the outer circumferential surface of the upper die 31 and the inner circumferential surface 33A of the body die 33, and the clearance between the outer circumferential surface of the lower die 32 and the inner circumferential surface 33A of the body die 33 are configured to between 0.1 μm and 10 μm or thereabouts.

When molding a lens 16 using the molding die 30 comprising the above-described configuration, the centering apparatus is configured to house the upper die 31 and the lower die 32 having a glass material held therebetween in the body die 33, and thereafter to soften the glass material by subjecting the glass material to heat of a prescribed temperature and to a prescribed pressure and press mold the lens 16. The optical surfaces 16A, 16B of the lens 16 are molded at this time by the molding surface 31A of the upper die 31 and the molding surface 32A of the lower die 32. At the same time, the outer peripheral surface 16F of the lens 16 is molded by the inner circumferential surface 33A of the body die 33, and, in addition, the planar surface 16C of the lens 16 is formed by the molding surface 31B of the upper die 31. A region that does not come in contact with the molding die and the glass material exists between the outer peripheral surface 16F and the planar surface 16C of the lens 16 at this time, and the surface 16G of the lens in this region is formed constituting a free surface having a curved surface shape. A free surface part 16E of the lens 16 is formed as a result of surplus glass material flowing into the runoff space 35 formed by the runoff part 32C of the lower die 32. The optical surfaces 16A, 16B of the lens 16 formed at this time may be either spherical surfaces or aspherical surfaces, but in either case, the optical surfaces 16A, 16B of the lens 16 are molded in a state in which the optical axis Jo of the lens 16 aligns with the central axis J3 of the molding die 30. The outer peripheral surface 16F of the lens 16 is molded parallelly and coaxially to the central axis J3 of the molding die 30.

### (3-2. Configuration of Positioning Unit)

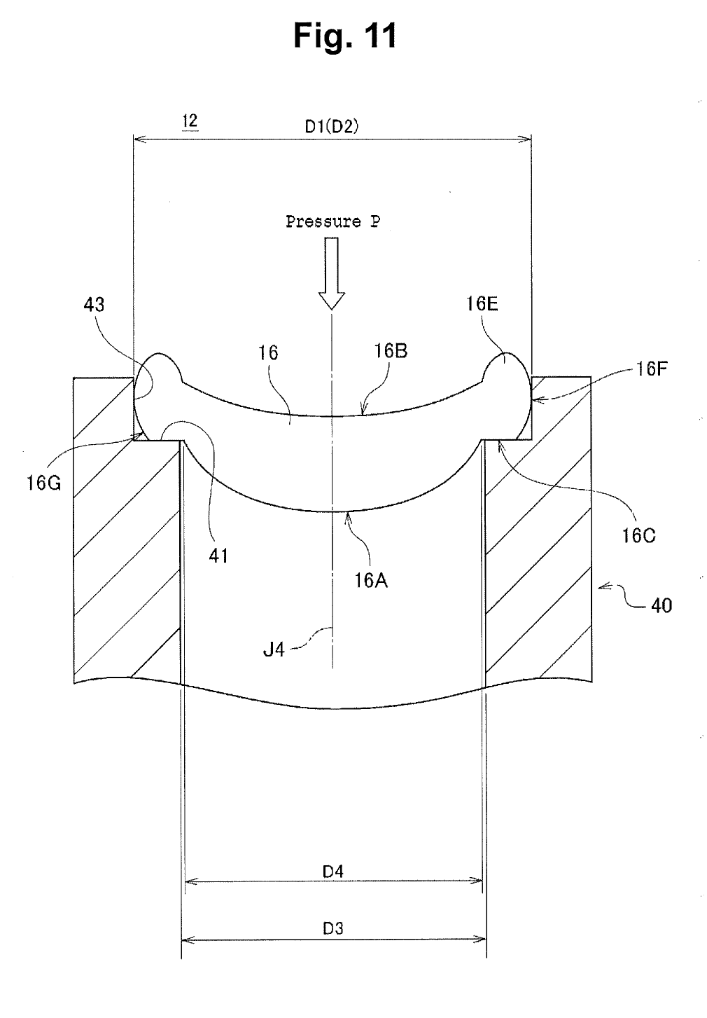

Next, the configuration of a positioning unit related to the third embodiment of the present invention will be explained using FIG. 11. Content that duplicates the explanations of the embodiments described hereinabove will be omitted.

FIG. 11 is a schematic cross-sectional view showing an example of the configuration of the positioning unit related to the third embodiment of the present invention.

The positioning unit in this embodiment differs from that of FIG. 4 described hereinabove in that the outer peripheral surface 16F of the lens 16 is formed so as to substantially make contact with an outer-peripheral-surface guidance part 43 of the positioning member 40 when a lens is supplied to the positioning unit. As used here, for example, “substantially make contact” signifies that the clearance between the outer peripheral surface 16F of the lens 16 and the outer-peripheral-surface guidance part 43 of the positioning member 40 is within 2 μm on one side.

The top end of the positioning member 40 is formed in the shape of a step with an inside diameter D2 that is larger than the outside diameter D1 of the lens 16 by the amount of the above-mentioned clearance, and the bottom portion of this step is a guidance part 41. The guidance part 41 is formed by forming a planar surface that is orthogonal to the reference axis J4 of the positioning member 40. Also, the diameter (bore diameter) D3 of the inner peripheral edge of the guidance part 41 is configured larger than the diameter D4 of the outer peripheral edge of the optical surface 16A of the lens 16.

### (3-3. Centering Method)

Next, a centering method related to the third embodiment of the present invention will be explained. In this centering method, a positioning unit of the above-described configuration is used.

First, as described hereinabove, the centering apparatus is configured to supply a lens 16 to the lens positioning part 12 from the lens supply/storage part 11 using the lens carrier apparatus 17 such that the planar surface 16C of the lens 16 and the guidance part 41 provided in the positioning member 40 make contact. At this time, the free surface part 16E of the lens 16 is oriented upwards at the top of FIG. 11, and the outer peripheral surface 16F of the lens 16 is substantially making contact with the outer-peripheral-surface guidance part 43 of the positioning member 40. The subsequent processes can be performed the same as in the embodiments described hereinabove.

### (3-4. Effects of the Third Embodiment)

In the third embodiment of the present invention, when centering a workpiece lens, the optical axis Jo of the lens 16 is highly accurately positioned with respect to the reference axis J4 of the positioning member 40 using the planar part 16c and the outer peripheral surface 16F of the lens 16, and since the positioned lens 16 is mounted in the holder 21 thereafter, it is possible to mount the lens 16 in the holder 21 with high positional precision. Specifically, it is possible to mount the lens 16 in the holder 21 without causing a shift-misalignment or a tilt-misalignment of the optical axis Jo of the lens 16 with respect to the central axis J2 of the holder 21. Thus, it is possible to keep lens 16 displacement to the minimum when mounting the lens 16 to the holder 21 or holding the lens 16 between the pair of holders 21, 22.

Also, according to the centering apparatus of the third embodiment, since both shift-misalignment and tilt-misalignment are corrected beforehand, it is possible to keep lens 16 displacement lower than the centering apparatus of the first embodiment. Therefore, the centering apparatus of the third embodiment can effectively prevent damage to the lens 16 and damage to the antireflective film resulting from rubbing against the pair of holders 21, 22, and possibly improve post-centering decentration precision.

### (3-5. Variation and so on)

The positioning member 40 shown in FIG. 11 described hereinabove has been explained as a fixed member, but the present invention is not limited thereto, and the positioning member 40 may be configured as a movable member. Specifically, the positioning member 40 may be configured using a left-right pair of movable members, and in a state in which the planar part 16C of the lens 16 is making contact with the guidance part 41 by the weight of the lens 16 itself, the outer-peripheral-surface guidance part 43 may be made to contact the outer peripheral surface 16F of the lens 16 by holding the lens 16 between the left-right pair of movable members at a prescribed pressure.

In the respective embodiments, in addition to the descriptions provided hereinabove, at least one of the magnitude of reflection decentration or the magnitude of transmission decentration of the post-centering lens 16 can be decreased.

A number of embodiments and a number of variations have been explained hereinabove, but these embodiments and variations are examples for illustrating the present invention, and do not purport to limit the scope of the present invention solely to these embodiments. That is, the present invention can be put into practice in a variety of other modes.

For example, the planar part of the lens 16 may be formed by the inner circumferential surface of the body die 33 in at least one of the embodiments and variations described hereinabove.

Furthermore, for example, the outer peripheral surface of the lens 16 may be formed by the upper die 31 and the lower die 32 in at least one of the embodiments and variations described hereinabove.

And, for example, at least one of the outer peripheral surface and the planar surface of the lens 16 may have a tapered surface in at least one of the embodiments and variations described hereinabove.

The outer peripheral surface of the lens 16 need not be a cylindrical surface around the entire circumference; a part of the outer peripheral surface of the lens 16 may be formed as a planar part (for example, the so-called D-cut lens or I-cut lens).

A mode in which the optical axis Jo of the lens 16 and the central axes J4, J5 of the positioning member 40 are either parallel or aligned when the lens 16 is positioned by the positioning member 40 has been explained, but the present invention is not limited thereto, and, for example, the optical axis Jo of the lens 16 can be corrected (correcting only the shift-misalignment) so as to intersect the central axes J4, J5 of the positioning member 40 when the lens 16 is positioned by the positioning member 40.

Lastly, the first through the third embodiments will be summarized using the drawings and so forth.

The centering method related to the first through the third embodiments of the present invention, as shown in FIG. 1 and FIGS. 3 through 11, is for centering the outer circumference of the lens 16 by holding the lens 16, which has been molded using the molding die 30, between a pair of holders 21, 22 of a bell clamp system, the centering method including: a first step of using first reference parts (planar parts 16C, 16D, and outer peripheral surface 16F) of the lens molded using the molding surfaces (31A, 32A, 31B, 32B, 33A) of the molding die 30 to position the lens 16 with respect to the second reference parts (guidance part 41, abutting reference surfaces 51A, 51B, 52A, 52B, upper surface 53A of lens bearing member, outer-peripheral-surface guidance part 43, and reference axes J4, J5) of the positioning members (positioning member 40, lens holding members 51, 52) capable of positioning the lens 16; and a second step of holding the lens 16 between the one holder 21 and the other holder 22 so that the optical axis Jo of the lens 16 positioned in the first step aligns with the central axis J2 of the one holder 21.

Preferably, in the centering method related to the first through the third embodiments of the present invention, the first reference parts (planar parts 16C, 16D and outer peripheral surface 16F) include the outer peripheral surface 16F of the lens 16 or the planar parts 16C, 16D extending in the radial direction from the outer peripheral edge of the optical surfaces 16A, 16B of the lens 16, as shown in FIG. 3(B), FIG. 5(B), FIG. 6(B), FIG. 9(B), and FIG. 10(B).

In addition, preferably, in the centering method related to the first through the third embodiments of the present invention, the molding die 30, as shown in FIGS. 3 through 11, comprises first molding surfaces (molding surfaces 31A, 32A) configures to mold the optical surfaces 16A, 16B of the lens 16, and second molding surfaces (molding surfaces 31B, 32B, 33A) providing third reference parts (molding surfaces 31B, 32B, 33A) configured to form the first reference parts (planar parts 16C, 16D and outer peripheral surface 16F) on the outer side of the first molding surfaces (molding surfaces 31A, 32A), and the lens is positioned so as to align the first reference parts (planar parts 16C, 16D and outer peripheral surface 16F) formed by the third reference parts (molding surfaces 31B, 32B, 33A) with the second reference parts (guidance part 41, abutting reference surfaces 51A, 51B, 52A, 52B, 52B and outer-peripheral-surface guidance part 43).

In addition, preferably, in the centering method related to the first and the third embodiments of the present invention, as shown in FIGS. 3 through 5, FIG. 10 and FIG. 11, the third reference parts (molding surfaces 31B, 32B) include on the second molding surfaces (molding surfaces 31B, 32B) planar parts 16C, 16D having planar surfaces orthogonal to the central axis J3 of the molding die 30, the first reference parts (planar parts 16C, 16D) are formed by the planar parts 16C, 16D being transferred to the lens 16 at press molding using the molding die 30, and the lens 16 is positioned so that the first reference parts (planar parts 16C, 16D) are configured to align with the second reference parts (guidance part 41 and outer-peripheral-surface guidance part 43).

Preferably, in the centering method related to the second and the third embodiments of the present invention, as shown in FIGS. 6 through 11, the third reference part (molding surface 33A) includes on the second molding surface (molding surface 33A) an outer circumferential surface part (molding surface 33A) parallel to the central axis J3 of the molding die 30, the outer circumferential surface part (molding surface 33A) is configured to mold the outer circumference of the lens 16, the first reference part (outer peripheral surface 16F) is formed by the outer peripheral surface part (outer peripheral surface 16F) being transferred to the lens 16 at press molding using the molding die 30, and the lens 16 is positioned so that the first reference part (outer peripheral surface 16F) aligns with the second reference parts (abutting reference surfaces 51A, 51B, 52A, 52B and outer-peripheral-surface guidance part 43).

In addition, preferably, in the centering method related to the first through the third embodiments of the present invention, as shown in FIG. 4, FIG. 7, FIG. 8, and FIG. 11, the second reference parts are the reference axes J4, J5 of the positioning member, and the positioning in the first step corrects the optical axis Jo so as to be parallel to the reference parts J4, J5.

In addition, preferably, the second reference parts are the reference parts J4, J5 of the positioning member, and the positioning of the first step corrects the optical axis Jo so as to intersect the reference parts J4, J5.

In addition, preferably, in the centering method related to the first through the third embodiments of the present invention, as shown in FIG. 1, the second step includes moving the lens 16 positioned in the first step from the location in which the lens 16 was positioned to the pair of holders 21, 22, and processing the lens 16 being held therebetween.

The following can be gleaned from the other aspects. The centering apparatus related to the first through the third embodiments of the present invention, as shown in FIG. 1, and FIGS. 3 through 11, is for centering the outer circumference of the lens 16 by holding the lens 16, which was molded using the molding die 30, between the pair of holders 21, 22 of the bell clamp system, and comprises a positioning unit configured to position the lens 16 with respect to the second reference parts (guidance part 41, abutting reference surfaces 51A, 51B, 52A, 52B, upper surface 53A of lens bearing member, outer-peripheral-surface guidance part 43, and reference axes J4, J5) of the positioning members (positioning member 40 and lens holding members 51, 52) configured to enable the positioning of the lens 16 using the first reference parts (planar parts 16C, 16D and outer peripheral surface 16F) of the lens 16, which were molded by the molding surfaces (31A, 32A, 31B, 32B, 33A) of the molding die 30, and a processing unit, which comprises the pair of holders 21, 22, and is configured to hold the lens 16 between the one holder 21 and the other holder 22 to center the outer circumference of the lens 16 so that the optical axis Jo of the lens 16 positioned by the positioning unit align with the central axis J2 of the one holder 21.

Preferably, in the centering apparatus related to the first through the third embodiments of the present invention, as shown in FIG. 3(B), FIG. 5(B), FIG. 6(B), FIG. 9(B), and FIG. 10(B), the first reference parts (planar parts 16C, 16D and outer peripheral surface 16F) include the outer circumference part of the lens 16, or the planar parts 16C, 16D extending in the radial direction from the outer peripheral edge of the optical surfaces 16A, 16B of the lens 16.

In addition, preferably, in the centering apparatus related to the first through the third embodiments of the present invention, as shown in FIGS. 3 through 11, the molding die 30 comprises first molding surfaces (molding surfaces 31A, 32A) configured to mold the optical surfaces 16A, 16B of the lens 16, and second molding surfaces (molding surfaces 31B, 32B, 33A) providing third reference parts (molding surfaces 31B, 32B, 33A) configured to form the first reference parts (planar parts 16C, 16D and outer peripheral surface 16F) on the outer side of the first molding surfaces (molding surfaces 31A, 32A), and the positioning unit is configured to position the lens 16 so as to align the first reference parts (planar parts 16C, 16D and outer peripheral surface 16F) formed by the third reference parts (molding surface 31B, 32B, 33A) with the second reference parts (guidance part 41, abutting reference surfaces 51A, 51B, 52A, 52B, and outer-peripheral-surface guidance part 43).

In addition, preferably, in the centering apparatus related to the first through the third embodiments of the present invention, as shown in FIGS. 3 through 5, FIG. 10 and FIG. 11, the third reference parts (molding surfaces 31B, 32B) include planar parts 16C, 16D having planar surfaces orthogonal to the central axis J3 of the molding die 30 on the second molding surfaces (molding surfaces 31B, 32B), the first reference parts (planar parts 16C, 16D) are formed by the planar parts 16C, 16D being transferred to the lens 16 at press molding using the molding die 30, and the positioning unit is configured to position the lens 16 so that the first reference parts (planar parts 16C, 16D) align with the second reference parts (guidance part 41 and outer-peripheral-surface guidance part 43).

In addition, preferably, in the centering apparatus related to the first and the third embodiments of the present invention, as shown in FIGS. 6 through 11, the third reference part (molding surface 33A) includes on the second molding surface (molding surface 33A) an outer circumferential surface part parallel to the central axis J3 of the molding die 30, the outer circumferential surface part is configured to mold the outer peripheral surface 16F of the lens 16, the first reference part (outer peripheral surface 16F) is formed by the outer peripheral surface part being transferred to the lens 16 at press molding using the molding die 30, and the positioning unit is configured to position the lens 16 so that the first reference parts (planar parts 16C, 16D and outer peripheral surface 16F) align with the second reference parts (abutting reference surfaces 51A, 51B, 52A, 52B and outer-peripheral-surface guidance part 43).

Preferably, in the centering apparatus related to the second and the third embodiments of the present invention, as shown in FIG. 4, FIG. 7, FIG. 8, and FIG. 11, the second reference parts are the reference axes J4, J5 of the positioning member, and the positioning performed by the positioning unit corrects the optical axis Jo so as to be parallel to the reference parts J4, J5.

In addition, preferably the second reference parts are the reference parts J4, J5 of the positioning member, and the positioning performed by the positioning unit corrects the optical axis Jo so as to intersect the reference parts J4, J5.

In addition, preferably, in the centering apparatus related to the first through the third embodiments of the present invention, as shown in FIG. 1, the second step includes moving the lens 16 positioned in the first step from the location in which the lens 16 was positioned to the pair of holders 21, 22, and processing the lens 16 being held therebetween.

In addition, the following can be gleaned from yet other aspects. The lens positioning unit related to the first through the third embodiments of the present invention, as shown in FIG. 1, and FIGS. 3 through 11, is the lens positioning unit in the centering apparatus is configured to center the outer circumference of the lens 16 by holding the lens 16, which was molded using the molding die 30, between the pair of holders 21, 22 of the bell clamp system, and is configured to position the lens 16 with respect to the second reference parts (guidance part 41, abutting reference surfaces 51A, 51B, 52A, 52B, and outer-peripheral-surface guidance part 43) of the positioning members (positioning member 40 and lens holding members 51, 52) configured to enable the positioning of the lens 16 prior to mounting the lens 16 in the one holder 21, wherein the lens 16 has first reference parts molded by the molding surfaces of the molding die 30, the lens positioning unit has the positioning members (positioning member 40 and lens holding members 51, 52) having second reference parts (guidance part 41, abutting reference surfaces 51A, 51B, 52A, 52B, and outer-peripheral-surface guidance part 43) configured to enable the positioning of the lens 16, and the lens positioning unit is configured to make it possible to position the lens 16 by bringing the first reference parts (planar parts 16C, 16D and outer peripheral surface 16F) either into contact with or close proximity to the second reference parts (guidance part 41, abutting reference surfaces 51A, 51B, 52A, 52B, and outer-peripheral-surface guidance part 43).

### REFERENCE SIGNS LIST

11 Lens supply/storage part
12 Lens positioning part
13 Lens processing part
16 Lens
16A, 16B Optical surfaces
16C, 16D Planar parts
16E Free surface part
16F Outer peripheral surface
21, 22 Holders
30 Molding die
31 Upper die
32 Lower die
33 Body die
31A, 32A Molding surfaces
31B, 32B Molding surfaces
33A Inner circumferential surface
40 Positioning member
41 Guidance part
51, 52 Lens holding members (positioning members)

1. A centering method for holding a workpiece lens, which has been molded using a molding die, between a pair of holders of a bell clamp system, and centering an outer circumference of the workpiece lens,
the method comprising:
a first step of using a first reference part of the workpiece lens, which has been formed using a molding surface of the molding die, to position the workpiece lens with respect to a second reference part of a positioning member configured to enable the positioning of the workpiece lens; and
a second step of holding the workpiece lens between one and the other of the holders so that the optical axis of the workpiece lens, which is positioned in the first step, aligns with the central axis of the one of the holders.

2. A centering method according to claim 1, wherein the first reference part includes the outer circumference part of the workpiece lens, or a planar part configured to extend in the radial direction from the outer peripheral edge of the optical surface of the workpiece lens.

3. A centering method according to claim 1, wherein the molding die has:
a first molding surface configured to mold the optical surface of the workpiece lens, and
a second molding surface configured to have a third reference part forming the first reference part on the outer side of the first molding surface,
the workpiece lens is positioned so as to align the first reference part, which is formed by the third reference part, with the second reference part.

4. A centering method according to claim 3, wherein
the third reference part includes a planar part having, on the second molding surface, a planar surface orthogonal to the central axis of the molding die, and
the first reference part is formed when the planar part is transferred to the workpiece lens during press molding using the molding die, and the workpiece lens is positioned so as to align the first reference part with the second reference part.

5. A centering method according to claim 3, wherein
the third reference part includes, on the second molding surface, an outer peripheral surface part parallel to the central axis of the molding die,
the outer peripheral surface part is configured to form the outer circumference of the workpiece lens, and
the first reference part is formed when the outer peripheral surface part is transferred to the workpiece lens during press molding using the molding die, and the workpiece lens is positioned so as to align the first reference part with the second reference part.

6. A centering method according to claim 1, wherein
the second reference part is a reference axis of the positioning member, and
the positioning in the first step corrects the optical axis so as to be parallel to the reference axis.

7. A centering method according to claim 1, wherein
the second reference part is the reference axis of the positioning member, and
the positioning in the first step corrects the optical axis so as to intersect the reference axis.

8. A centering method according to claim 1, wherein the second step includes moving the workpiece lens that has been positioned in the first step from the position, in which the workpiece lens has been positioned, to the pair of holders, and processing the workpiece lens held therebetween.

9. A centering apparatus for holding a workpiece lens, which is molded using a molding die, between a pair of holders of a bell clamp system and centering the outer circumference of the workpiece lens,
the centering apparatus comprising:
a positioning unit configured to use a first reference part of the workpiece lens, which has been molded by a molding surface of the molding die, to position the workpiece lens with respect to a second reference part of a positioning member configured to enable to position the workpiece lens; and
a processing unit configured to have a pair of holders for holding the workpiece lens, which has been positioned by the positioning unit, between one and the other holders so that the optical axis of the workpiece lens aligns with the central axis of one of the holders, and configured to process centering for the outer circumference of the workpiece lens.

10. A centering apparatus according to claim 9, wherein the first reference part includes the outer circumference of the workpiece lens, or a planar part configured to extend in the radial direction from the outer peripheral edge of the optical surface of the workpiece lens.

11. A centering apparatus according to claim 9, wherein the molding die has:
a first molding surface configured to mold the optical surface of the workpiece lens, and
a second molding surface configured to have a third reference part for forming the first reference part on the outer side of the first molding surface,
the positioning unit is configured to position the workpiece lens so as to align the first reference part formed by the third reference part with the second reference part.

12. A centering apparatus according to claim 11, wherein
the third reference part includes a planar part having, on the second molding surface, a planar surface orthogonal to the central axis of the molding die, and
the first reference part is formed when the planar part is transferred to the workpiece lens during press molding using the molding die, and the positioning unit is configured to position the workpiece lens so as to align the first reference part with the second reference part.

13. A centering apparatus according to claim 11, wherein
the third reference part includes, on the second molding surface, an outer peripheral surface part parallel to the central axis of the molding die,
the outer peripheral surface part is configured to form the outer circumference of the workpiece lens, and
the first reference part is formed when the outer peripheral surface part is transferred to the workpiece lens during press molding using the molding die, and the positioning unit is configured to position the workpiece lens so as to align the first reference part with the second reference part.

14. A centering apparatus according to claim 9, wherein
the second reference part is the reference axis of the positioning member, and
the positioning performed by the positioning unit corrects the optical axis so as to be parallel to the reference axis.

15. A centering apparatus according to claim 9, wherein
the second reference part is the reference axis of the positioning member, and
the positioning performed by the positioning unit corrects the optical axis so as to intersect the reference axis.

16. A centering apparatus according to claim 9, wherein the second step includes moving the workpiece lens that has been positioned in the first step from the position, in which the workpiece lens has been positioned, to the pair of holders, and processing the workpiece lens held therebetween.

17. A centering unit for holding a workpiece lens, which has been molded using a molding die, between a pair of holders of a bell clamp system and centering an outer circumference of the workpiece lens, the lens positioning unit implementing positioning of the workpiece lens prior to mounting the workpiece lens to one of the holders, wherein
the workpiece lens has a first reference part molded by a molding surface of the molding die,
the lens positioning unit has a positioning member having a second reference part configured to enable the positioning of the workpiece lens, and
the lens positioning unit is configured to enable the positioning of the workpiece lens by either bringing the first reference part into contact with or close proximity to the second reference part.
